(19) United States
(12) Patent Application Publication
(10) Pub. No.: US 2015/0195314 A1
(43) Pub. Date: Jul. 9, 2015

(54) METHOD AND SYSTEM FOR DISTRIBUTED COLLECTION AND DISTRIBUTION OF PHOTOGRAPHS

(71) Applicant: Snapcious LLC, West Hollywood, CA (US)

(72) Inventors: Joseph McKean Reed, Los Angeles, CA (US); Yael Swerdlow, West Hollywood, CA (US)

(21) Appl. No.: 14/588,891

(22) Filed: Jan. 2, 2015

Related U.S. Application Data
(60) Provisional application No. 61/923,448, filed on Jan. 3, 2014.

(51) Int. Cl. H04L 29/06; G06F 17/30

(52) U.S. Cl. CPC H04L 65/403; G06F 17/30899

(57) ABSTRACT

Methods and systems crowdsourcing collection and distribution of photographs. A network of computing devices communicates with a content storage and client computing devices operated by users. The network includes application instance computing devices that register users, receive photographs from users (after a description of a common theme has been published), and store photographs in the content storage. Identifications of multiple external and independently operated social networks are received for each photograph, and each photograph is posted on the social networks identified for the photograph. After these posts, a new registration request is received from a new user. After the new user is registered, a new photograph is received from the new user and stored in the content storage. The new photograph is associated with new identifications of social networks, and posted on the social networks identified in the new identifications to thereby crowdsource collection of photographs across the social networks.

### CROSS REFERENCE TO RELATED APPLICATION(S)

This application claims the benefit of U.S. Provisional Application No. 61/923,448, filed on Jan. 3, 2014, which is incorporated herein by reference in its entirety.

### BACKGROUND OF THE INVENTION

1. Field of the Invention

The present invention is directed generally to methods and systems that use a computer network to collect and distribute photographs.

2. Description of the Related Art

FIG. 1 illustrates how a user interacts with commonly used online photograph contests. First, an entity (referred to as a “brand”) advertises a contest and instructs users to post photographs on a target network (e.g., Instagram). Next, a user sees the advertisement and snaps a photograph. Then, the user posts the photograph to the target network, and adds a hashtag (e.g., “BLABLABLA #HASHTAB”) manually. Unfortunately, users frequently forget hashtags, apply them inconsistently, or misspell them. Further, the user is operating separately from the brand, which means that the brand is unable to communicate with the user or otherwise shape the user's experience. At the end of the contest, the brand selects a winner manually and the winner is announced by either the brand or the target network.

Unfortunately, this conventional approach limits a photograph contest to a single target network. In other words, only users who view the contest on the target network may participate, which restricts participation in the contest. Further, the conventional approach greatly restricts a user's ability to solicit, collect, post, and rate photographs related to a particular subject of interest.

Therefore, a need exists for methods and systems that allow user to solicit, collect, post, and rate photographs related to a particular subject of interest on multiple target sites at the same time. The present application provides these and other advantages as will be apparent from the following detailed description and accompanying figures.

### SUMMARY OF THE INVENTION

Embodiments include a system including a content storage and a network of computing devices. The content storage is configured to store user information for a plurality of users, and a plurality of photographs. Each of the photographs is associated with a common theme. The network of computing devices is configured to communicate with the content storage and a plurality of client computing devices operated by the plurality of users. The network of computing devices includes a plurality of application instance computing devices that when operating independently or together are configured to collect the user information from the plurality of users and store the user information in the content storage to thereby register the plurality of users with the network of computing devices. A plurality of photographs are received from the plurality of users (via the plurality of client computing devices) after a description of the common theme has been published. The plurality of photographs are stored in the content storage. For each of the plurality of photographs, identifications of multiple external and independently operated social networks upon which the photograph is to be posted are received, and each of the plurality of photographs is posted on the social networks identified in the identifications associated with the photograph. In response to the posting, a new request to register with the network of computing devices is received from a new client computing device operated by a new user. The new user is registered with the network of computing devices by collecting new user information from the new user and storing the new user information in the content storage. A new photograph is received from the new client computing device after the new user has been registered. The new photograph is associated with new identifications of ones of the social networks upon which the new photograph is to be posted. The new photograph is stored in the content storage, and posted on the social networks identified in the new identifications to thereby crowdsource collection of photographs across the multiple external and independently operated social networks.

The application instance computing device(s) may be configured to automatically generate a hashtag associated with each of the plurality of photographs, store the hashtag associated with each photograph in the content storage, post the hashtag associated with each of the plurality of photographs along with the photograph, automatically generate a new hashtag and associate the new hashtag with the new photograph, store the new photograph and the new hashtag in the content storage, and post the new hashtag along with the new photograph.

The common theme may be associated with a company that is associated with a website, and the application instance computing device(s) may be configured to provide the plurality of photographs and the new photograph to the website for display thereby.

The application instance computing device(s) may be configured to receive a rating for the new photograph from at least one of the plurality of users, and display the rating to the plurality of users and the new user.

The application instance computing device(s) may be configured to receive ratings for each of the plurality of photographs and the new photograph from the plurality of users, and select a winning photograph based upon the ratings.

Embodiments include a computer implemented method that includes registering (by a computer system) a plurality of users each operating a different client computing device. In response to a description of a theme having been published, a different photograph is received (at the computing system) from each of the different client computing devices. Each photograph is associated with identifications of multiple external and independently operated social networks upon which the photograph is to be posted. Each photograph is posted (by the computer system) on the social networks identified in the identifications associated with the photograph. Posting each photograph may include providing at least one hashtag with the photograph. In response to the posting, a new request to register with the computer system is received (at the computer system) from a new client computing device operated by a new user. The new user is registered by the computer system. A new photograph is received (at the computer system) from the new client computing device after the new user has registered with the computing system. The new photograph is associated with new identifications of ones of the social networks upon which the new photograph is to be posted. The new photograph is posted on the social networks identified in the new identifications to thereby crowdsource collection of photographs across the multiple external and independently operated social networks.

The method may include providing a copy of a client application to each of the client computing devices and the new client computing device. In such embodiments, each of the plurality of users may be registered via the copy of the client application provided to the client computing devices operated by the users. The new user may be registered via the copy of the client application provided to the new client computing device operated by the new user. The client application may be configured based on the theme, and posting each different photograph may include providing at least one hashtag with the photograph. The hashtag may be associated with the theme. The theme may be associated with a company that is associated with a website. Each of the photographs and the new photograph may be provided to the website for display thereby.

The method may include receiving a rating for the new photograph from at least one of the plurality of users, and displaying the rating to the plurality of users and the new user.

The method may include receiving ratings for each of the photographs and the new photograph from the plurality of users. A winning photograph may be selected based upon the ratings.

### BRIEF DESCRIPTION OF THE SEVERAL VIEWS OF THE DRAWING(S)

FIG. 1 illustrates a prior art method of implementing a photograph contest.

FIG. 2 is a diagram of a system configured to collect and distribute photographs using crowdsourcing.

FIG. 3 illustrates a method of using the system of FIG. 2 to crowdsource the collection and distribution of photographs.

FIG. 4A is a diagram of a platform of the system of FIG. 2.

FIG. 4B is a block diagram illustrating exemplary software modules and data that may be stored in a system memory of a content storage of the platform of FIG. 4A.

FIG. 4C is a block diagram illustrating a load balancing module stored in a system memory of a load balancer of the platform of FIG. 4A.

FIG. 4D is a block diagram illustrating exemplary software modules that may be stored in a system memory of one or more application instance computing devices 160 of the platform of FIG. 4A.

FIG. 5A illustrate a first portion of software deployed on the computer systems of the platform of FIG. 4A.

FIG. 5B illustrate a second portion of software deployed on the computer systems of the platform of FIG. 4A.

FIG. 5C illustrate a third portion of software deployed on the computer systems of the platform of FIG. 4A.

FIG. 6A depicts an exemplary contest (or “mission”) interface.

FIG. 6B depicts an exemplary camera interface.

FIG. 6C depicts an exemplary photograph view interface.

FIG. 6D depicts an exemplary user profile interface.

FIG. 6E depicts an exemplary user metadata interface.

FIG. 6F depicts an exemplary friends interface.

FIG. 6G depicts an exemplary new ideas interface.

FIG. 6H depicts an exemplary user ideas interface.

FIG. 6I depicts an exemplary message interface.

FIG. 6J depicts an exemplary user stats interface.

FIG. 6K depicts an exemplary leaderboard interface.

FIG. 6L depicts an exemplary sharing interface.

FIG. 7 is a flow diagram of an exemplary method of collecting and distributing photographs using crowdsourcing using the system of FIG. 2.

FIG. 8 is a flow diagram of a method of implementing such social activities using the system of FIG. 2.

FIG. 9 is a flow diagram of a method performed by a brand operating a customer computing systems.

FIG. 10 is a flow diagram of a method performed by a user operating a client computing devices.

FIG. 11 is a flow diagram of a method performed by the platform of FIG. 4A.

FIG. 12 is a diagram of a hardware environment and an operating environment in which the computing devices of the system of FIG. 2 and the platform of FIG. 4A may be implemented.

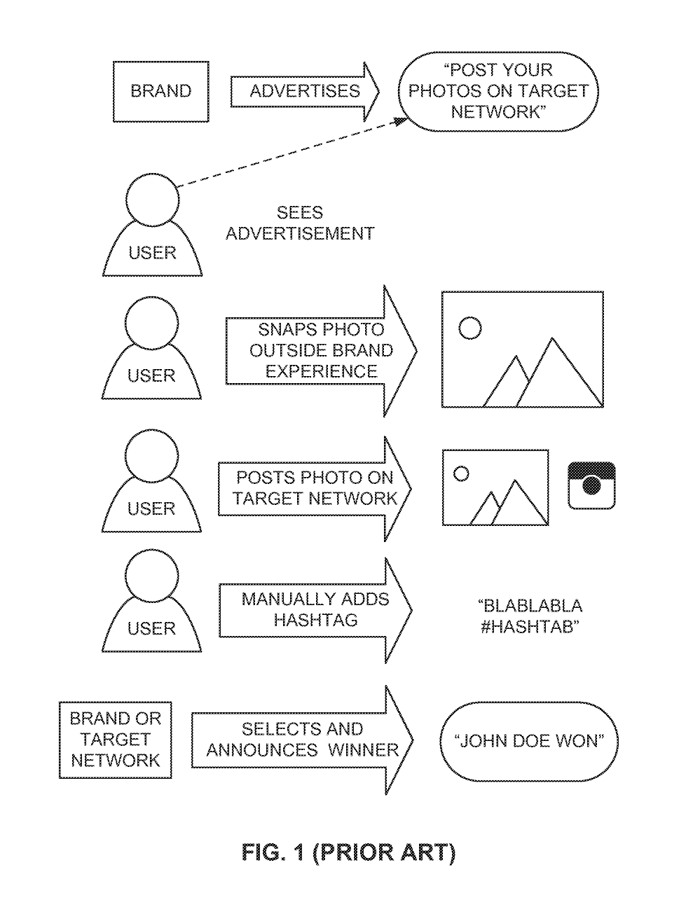

### DETAILED DESCRIPTION OF THE INVENTION

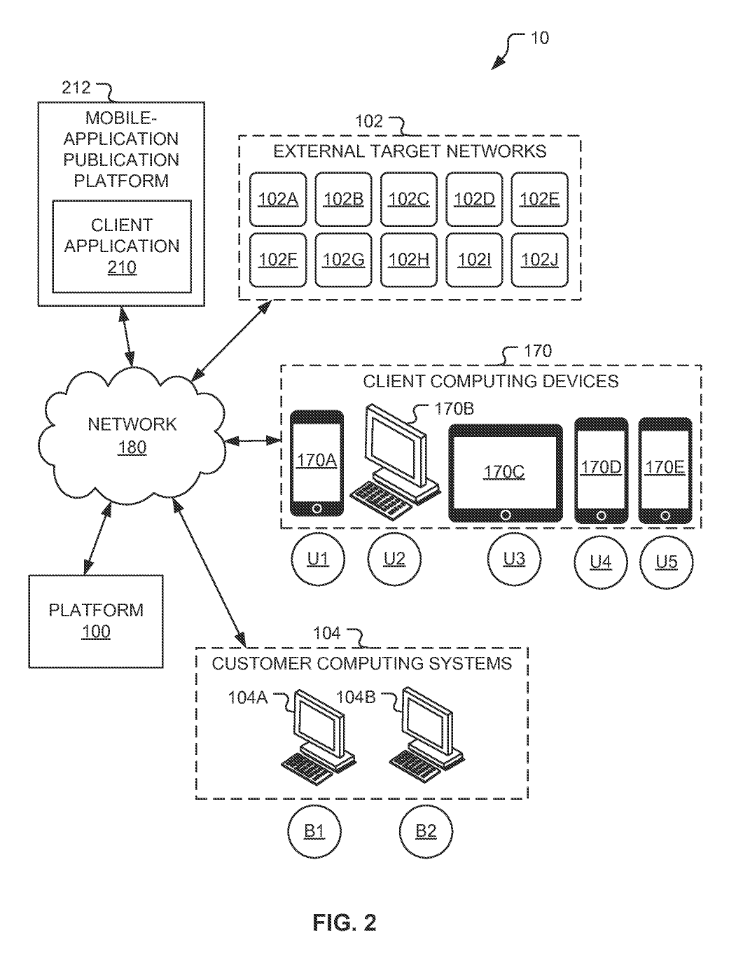

FIG. 2 illustrates a system 10 that includes a software/hardware platform 100 configured to interact with a client application 210 installed and executing on one or more client computing devices 170. The client application 210 may be stored by a mobile-application publication platform 212 and distributed thereby via a network 180 (e.g., the Internet) to the client computing devices 170. The client computing devices 170 are each configured to execute a copy of the client application 210. In the embodiment illustrated, the client computing devices 170 include client computing devices 170A-170E operated by users U1-U5, respectively.

Within the system 10, the platform 100 may be connected via the network 180 to each of a plurality of external target networks 102, which include social networking sites, such as Facebook, Twitter, Instagram, Pinterest, Tumblr, Flickr, Google+, WeChat, LinkedIN, WhatsApp, and the like. In the embodiment illustrated, the external target networks 102 include ten external target networks 102A-102J.

The platform 100 may be connected via the network 180 to one or more customer computing systems 104. In the embodiment illustrated, the customer computing systems 104 include customer computing systems 104A and 104B operated by customers or brands B1 and B2, respectively. The brands B1 and B2 may each be a company, a business name, a trademark, and the like. As is apparent to those of ordinary skill in the art, the brands B1 and B2 are each controlled by one or more entities. The users U1-U5 may be consumers (or potential consumers) of one or more of the brands B1 and B2.

The platform 100 may create a contest automatically based on information provided by one of the brands B1 and B1 or one of the users U1-U5. For example, the platform 100 may create contests automatically in custom-written categories using top-ranked ideas provided by the users U1-U5. Alternatively, the platform 100 may create contests based on direct input from one of the brands B1 and B1 or one of the users U1-U5 using pre-written (or predefined) categories. This method allows the author of the contest to have stronger editorial control.

In the embodiment illustrated in FIG. 2, the client computing devices 170 include the five client computing devices 170A-170E operated by the users U1-U5, respectively. Further, FIG. 2 illustrates the two brands B1 and B2 operating the customer computing systems 104A and 104B, respectively. Additionally, FIG. 2 illustrates the single mobile-application publication platform 212, and the ten external target networks 102A-102J. FIG. 2 also illustrates a single instance of the platform 100. However, the system 10 may include any number of users and brands each operating any number of computing devices. Further, the system 10 may include any number of client computing devices, external target networks, customer computing systems, mobile-application publication platforms, and instances of the platform 100. Additionally, the system 10 may include more than one client application like the client application 210. For example, a different client application like the client application 210 may be created and distributed for each of the brands B1 and B2. By way of another non-limiting example, a different client application like the client application 210 may be created and distributed for particular contests.

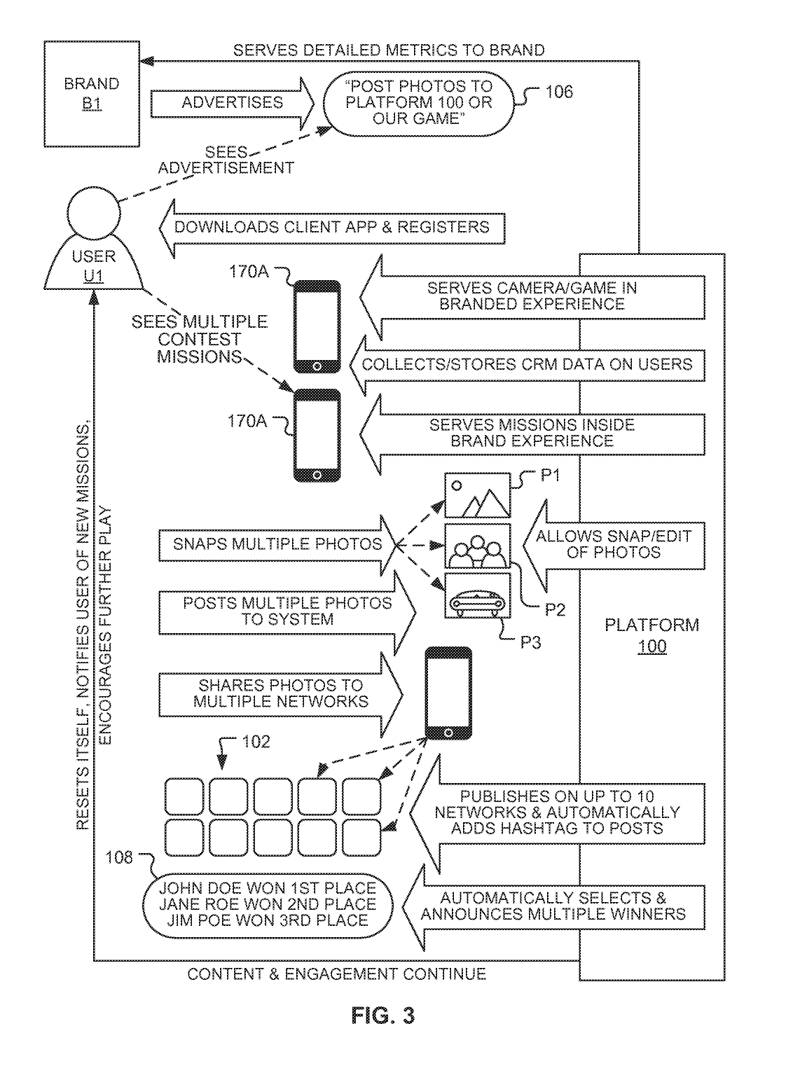

FIG. 3 provides an overview of some of the functionality provided by the system 10. Referring to FIG. 3, one of the brands B1 and B2 issues an advertisement 106 advertising a mission (e.g., a contest or a game). For ease of illustration, in FIG. 3, the advertisement 106 was issued by the brand B1 and includes the following text: “POST PHOTOS TO PLATFORM 100 OR OUR GAME.”

One or more of the users U1-U5 each sees the advertisement 106. For ease of illustration, in FIG. 3, the user U1 sees the advertisement. Then, the user U1 downloads a copy of the client application 210 (e.g., from the mobile-application publication platform 212 illustrated in FIG. 2) to the client computing device 170A and registers with the platform 100. During the registration process, the user U1 creates a user profile (described below).

The client application 210 may be configured to provide a brand (or branded) experience to the users U1-U5. For example, a different version of the client application 210 may be created by each of the brands B1 and B2. Thus, the client application 210 allows the brands B1 and B2 to shape a user's experience and provides a way for the brands B1 and B2 to communicate with the user. This type of user experience is referred to herein as an in brand (or branded) experience.

The platform 100 serves a camera/game (in branded experience) to the client application 210 executing on the client computing device 170A. The platform 100 also collects and stores Customer Relationship Management (“CRM”) data on users. Further, the platform 100 serves missions inside the brand experience to the client application 210 executing on the client computing device 170A.

The user U1 sees the missions displayed by the client application 210 (see FIG. 2) executing on the client computing device 170A and selects one of those missions. The platform 100 allows the user U1 to snap and edit photographs. The user U1 snaps multiple photographs P1-P3 and posts them to the platform 100 using the client application 210 executing on the client computing device 170A. Next, the user U1 identifies on which of the external target networks 102, the user U1 would like to share the photographs P1-P3.

The platform 100 publishes the photographs P1-P3 to the identified external target networks 102 and automatically adds hashtags to those posts. The hashtags may be related or associated with the brand B1. Unique hashtags may be established for each customer (e.g., the brands B1 and B2), and for each contest. The platform 100 automatically publishes these hashtags with every photograph published by the users U1-U5 (using the client application 210) to the external target social networks 102. This allows the platform 100 to be used for embedded social marketing of—among many other things—goods, services, events, brands, non-governmental organizations, non-profit organizations, and other organizations.

At a later time, the platform 100 automatically selects and announces multiple winners (e.g., in an announcement 108). The platform 100 also serves detailed metrics (e.g., CRM data) to the brand B1.

After the mission ends, the platform 100 continues providing content to the user U1 (via the client application 210 executing on the client computing device 170A). Thus, engagement between the user U1 and the platform 100 also continues. The platform 100 may reset itself, notify the user U1 of new missions, and encourage further game play.

Thus, referring to FIG. 2, the platform 100 is configured to solicit photographs from the users U1-U5 (via the network 180) and distribute those user submitted photographs across the multiple external target networks 102. The solicitation may be characterized as being a charge (or mission) linked to a theme. The charge may textual or verbal (e.g., like the advertisement 106 depicted in FIG. 3). The charge may originate from one of the users U1-U5 or be supplied by one of the brands B1 and B2.

The platform 100 may verify and/or rank the user submitted photographs (e.g., the photographs P1-P3). The photographs may be categorized based on the charge and distributed in a targeted manner using hashtags automatically provided by the platform 100. As the above example shows, the photographs may be collected as part of a photograph contest or game. However, this is not a requirement.

Together, the photographs collected form a visual conversation or communication around the charge or theme. Further, those users who contribute photographs to the visual conversation may be characterized as a community formed around that visual conversation. Thus, the system 10 implements a method of communication that is impossible outside a networked computer environment. The platform 100 may be used to focus crowdsourced visual communication (using photographs) around a specific theme, such that the resulting collection of photographs are published with user-defined and/or administrator-defined context attached thereto via hashtags, URLs and the specific theme itself.

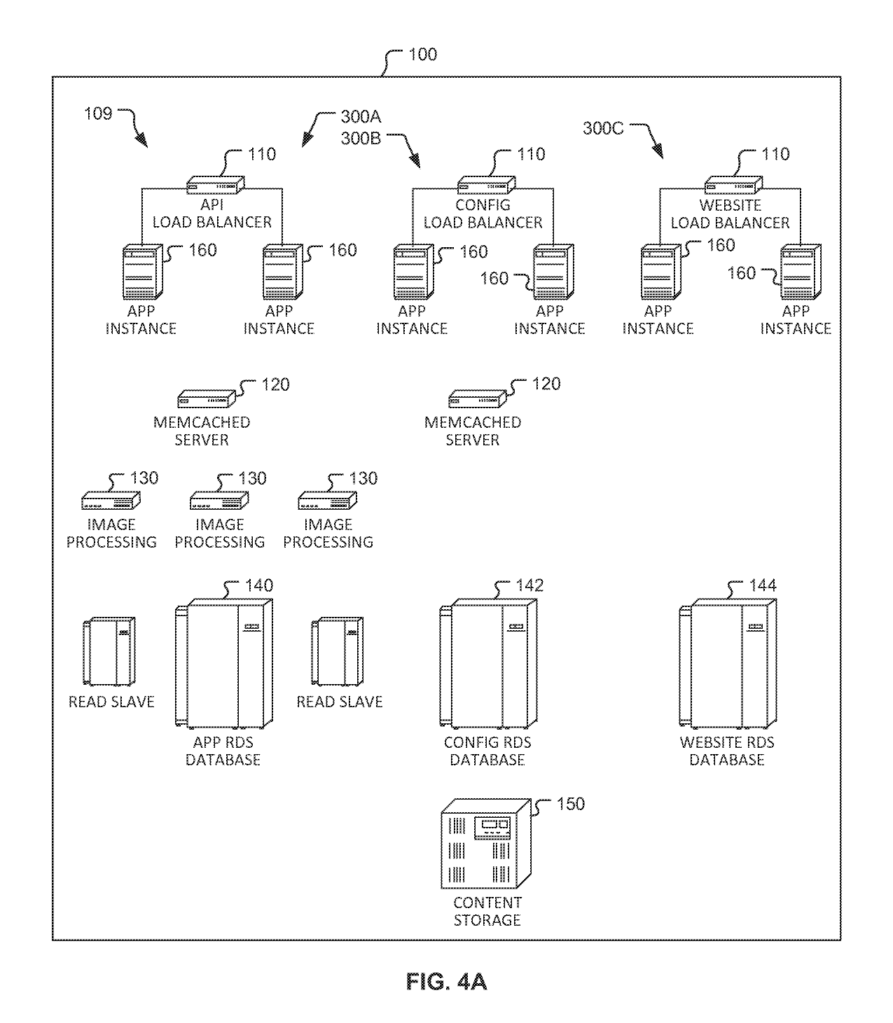

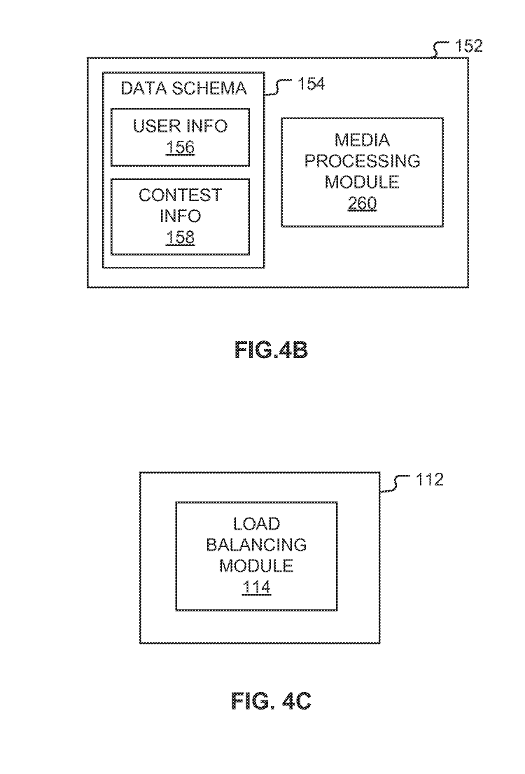

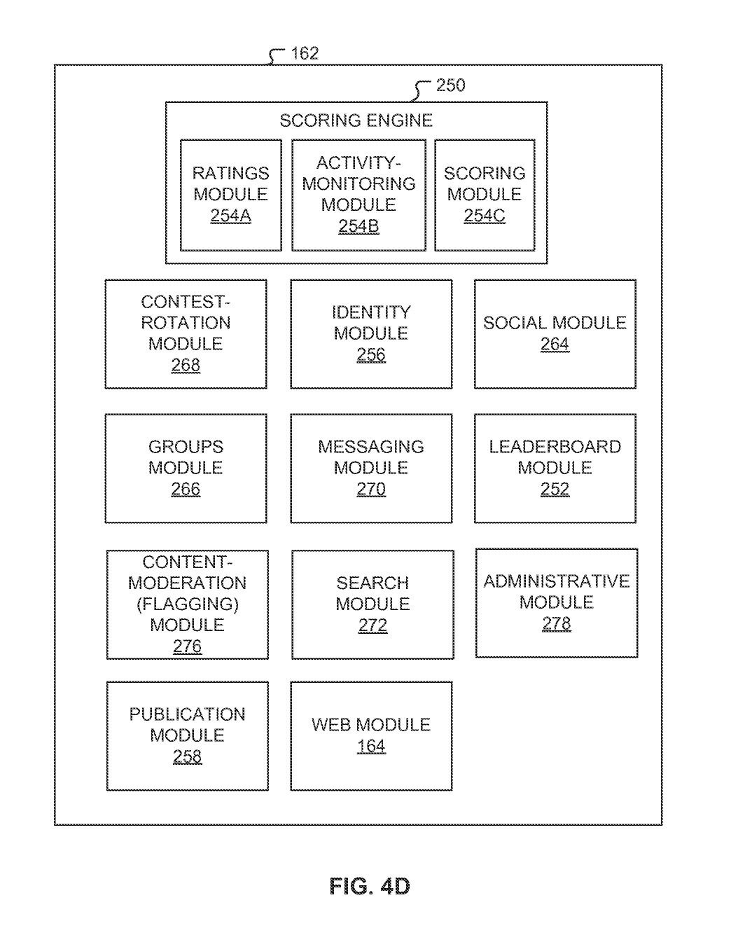

FIG. 4A illustrates a network 109 of several distinct computer systems configured to implement the platform 100 and perform methods implementing a social community centered around the collection of photographs (e.g., obtained via a photograph contest). For ease of illustration, the collection will be described as occurring as part of a photograph contest, which may be offered on a recurring basis with the same or different parameters. By way of non-limiting examples, the platform 100 may be used to market goods, services, brands, events, causes, and the like. By way of other non-limiting examples, the platform 100 may be used to crowdsource and/or crowd-vet canonical photographs of locations, landmarks, businesses, and the like. By way of yet another non-limiting example, the platform 100 may be used to crowd-source and/or crowd-vet photographs for purposes of citizen journalism.

As mentioned above, the platform 100 includes the network 109 of computer systems, which perform a variety of functions. These computer systems include load balancers 110, memcached servers 120, image-processing servers 130, relational-database servers (including, for example, an application database server 140, a configuration database server 142, and a website database server 144), and a content storage 150 (e.g., an Amazon S3).

Within the platform 100, the computers are connected to one another. Each of the load balancers 110 may be connected to a plurality of application instance computing devices 160. Each of the application instance computing devices 160 may be connected to one or more client computing devices 170 (see FIG. 2) operated by the users U1-U5.

In the embodiment illustrated, the platform 100 may be characterized as including an application (or application programming interface (“API”)) subsystem 300A, a configuration subsystem 300B, and a website subsystem 300C. Each of the subsystems 300A-300C may include one or more of the load balancers 110, the application instance computing devices 160, the memcached servers 120, and the image-processing servers 130. The subsystems 300A-300C include the application database server 140, the configuration database server 142, and the website database server 144, respectively. The subsystems 300A-300C may each be connected to the shared content storage 150.

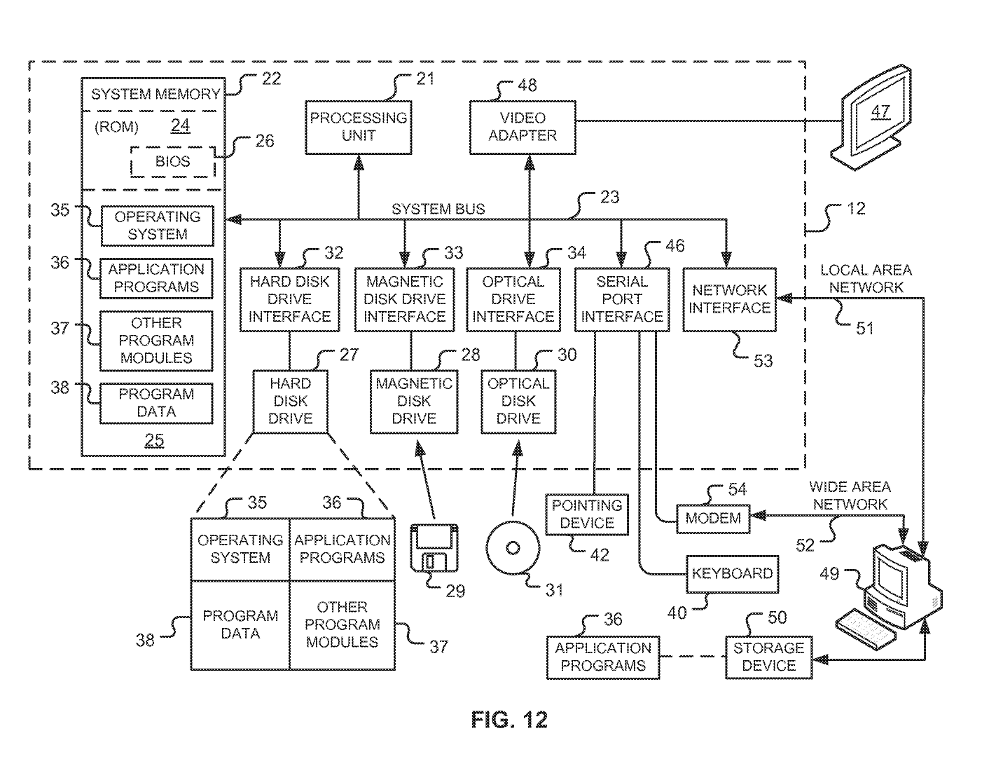

FIG. 4B depicts exemplary software modules and data that may be stored in a system memory 152 (like a system memory 22 depicted in FIG. 12 and described below) of the content storage 150. Referring to FIG. 4B, the content storage 150 (e.g., cloud-based servers) stores and serves a data schema 154. The data schema 154 allows for the reading, writing, editing, and publishing of user information 156 and contest information 158. The user information 156 may include user identity information, which may include profile data (such as name, email address, geographic location, personal likes/dislikes, etc.). The user information 156 may include an avatar, and a content display (identifying content created by the user to be displayed to other users). The contest information 158 may include or identify a category, a contest in the context of the category, and history with respect to all contests served by the platform 100.

The content storage 150 stores and serves the media processing and publication modules 258 and 260. The media processing and publication modules 258 and 260 implement reading, writing, editing, and publication of user-generated content (including photographs, captions, and metadata). The media processing and publication modules 258 and 260 implement uploading raw photographs and converting raw photographs into a variety of sizes and file-weights for multiple purposes. For example, a raw photograph may be converted for full-size display or into thumbnails for an in-situ reference to the contest to which they have been submitted. By way of another non-limiting example, the raw photographs may be modified to include in-situ references to the users who created them.

Each of the computer systems illustrated in FIGS. 2 and 4A may be implemented by one or more computing devices like a computing device 12 (described below and depicted in FIG. 12).

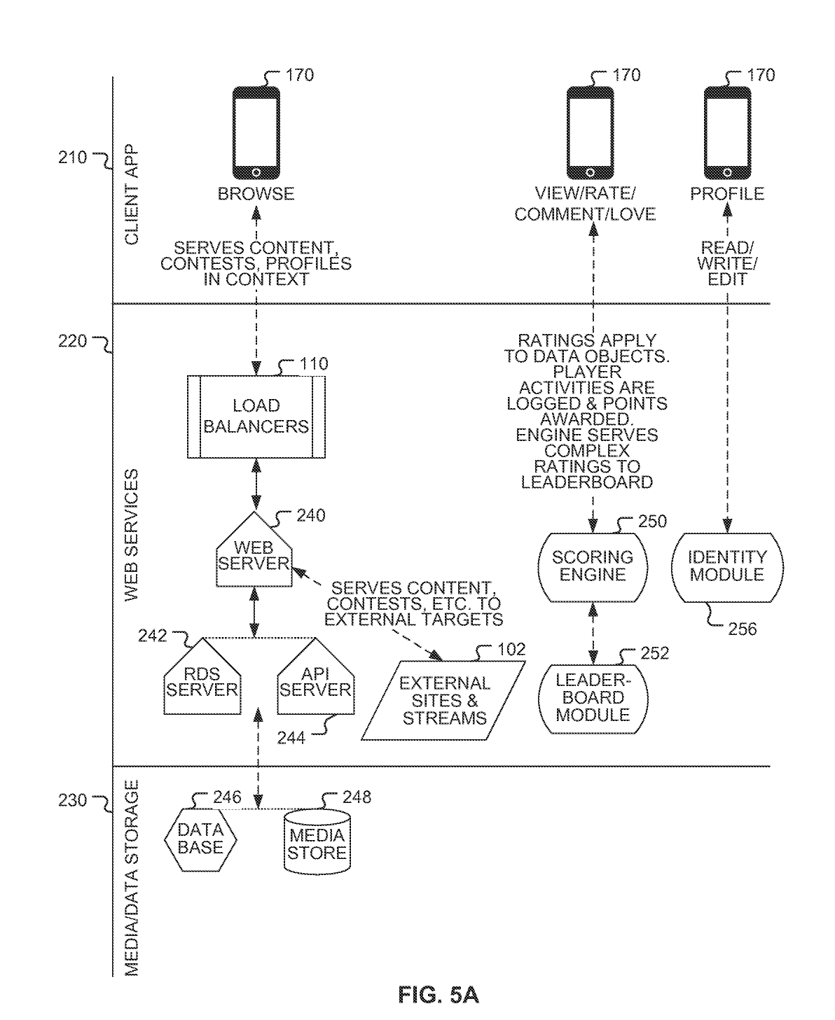

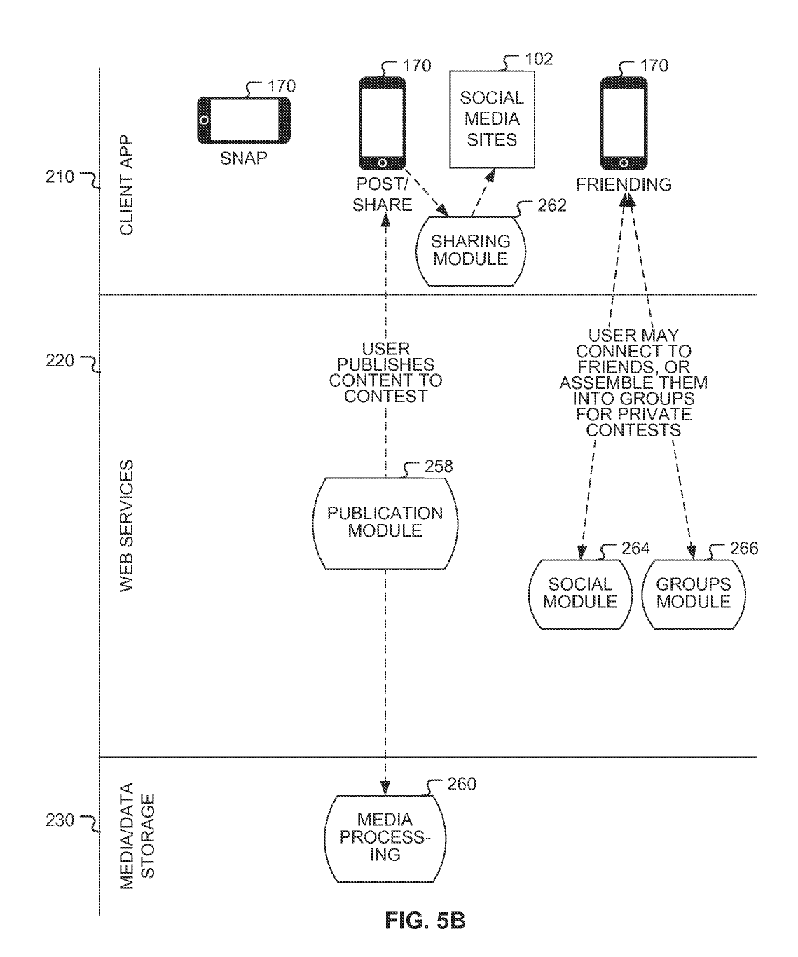

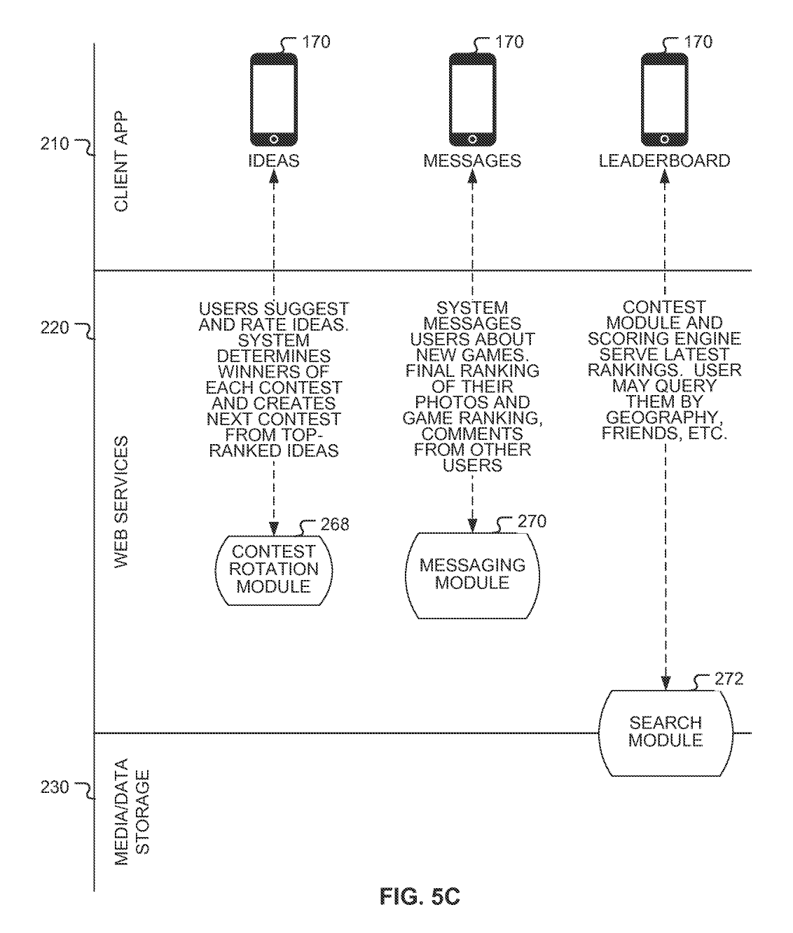

FIGS. 5A-5C illustrate software deployed on the computer systems of the platform 100. Referring to FIGS. 5A-5C, the platform 100 may be characterized as including three subcomponents: the client application 210, web services 220, and a media/data storage 230.

The client application 210 allows users to create, edit, preview, and post photographs using the device's onboard hardware camera. The client application 210 allows users to delete photos they have already posted. Further, the client application 210 allows users to create and post contest ideas. The client application 210 allows users to view and interact with contest content by gestural controls. Such interaction includes browsing photos and contest ideas, rating photos and contest ideas, marking photos as “Loved,” posting comments with respect to photos, and flagging content (for system administrators) as inappropriate for other users. The client application 210 allows users to view and interact with the profiles of other users, which includes following, unfollowing, friending, and unfriending other users. The client application 210 allows users to share their own contest content (and content authored by other Users) on social media sites and/or networks, such as Facebook, Twitter, Instagram, Pinterest, Tumblr, Flickr, Google+, WeChat, LinkedIN, and WhatsApp.

Referring to FIGS. 5A-5C, from left to right, the client application 210 provides browse functionality, view/rate/comment/love functionality, profile functionality, snap (or image capture) functionality, post/share functionality, friending functionality, ideas functionality, messages functionality, and leaderboard functionality.

### Browse Functionality

Referring to FIG. 5A, the client application 210 is configured to interact with the web services 220 to provide browse functionality. One of the load balancers 110 (e.g., the load balancer 110 of the website subsystem 300C (see FIG. 4A)) serves content, contests (e.g., themes), and/or profiles in context to the client application 210. The load balancer 110 communicates with a web server 240 (e.g., one of the application instance computing devices 160 of the website subsystem 300C)

Referring to FIG. 4C, the load balancers 110 each implement a load balancing module 114 stored in a system memory 112 (like a system memory 22 depicted in FIG. 12 and described below). The load balancing module 114 provides on-the-fly management of fluctuation in read/write web traffic.

Referring to FIG. 5A, the web server 240 serves content, contests, etc., to two or more of the external target networks 102. To accomplish this, the web server 240 interacts with a RDS server 242 (e.g., one of the application instance computing devices 160 of the application subsystem 300A) and an API server 244 (e.g., one of the application instance computing devices 160 of the application subsystem 300A). The RDS and API servers 242 and 244 are configured to interact with the media store 248 to provide browse functionality. The RDS and API servers interact with a database 246 (e.g., the application database server 140) and a media store 248 (e.g., the content storage 150) in the media/data storage 230 to store content and retrieve and distribute stored content.

FIG. 4D depicts exemplary software modules that may be stored in a system memory 162 (like a system memory 22 depicted in FIG. 12 and described below) of one or more of the application instance computing devices 160. Referring to FIG. 4D, a web module 164 executing on one or more of the application instance computing devices 160 implements the web server 240 and the API server 244. The web module 164 serves contests and their content in customizable modules in a variety of situations. For example, the web module 164 may serve serves contests and their content to the client application 210, websites (e.g., associated with and/or controlled by the brands B1 and B2), and social-media streams (e.g., Facebook, Twitter, Pinterest, etc.).

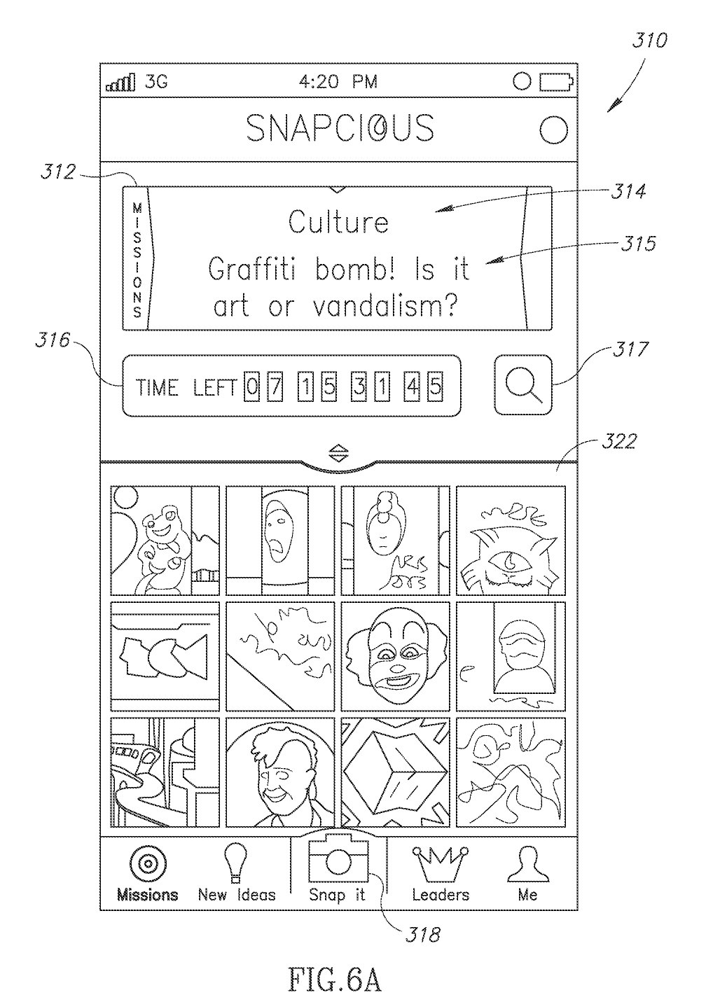

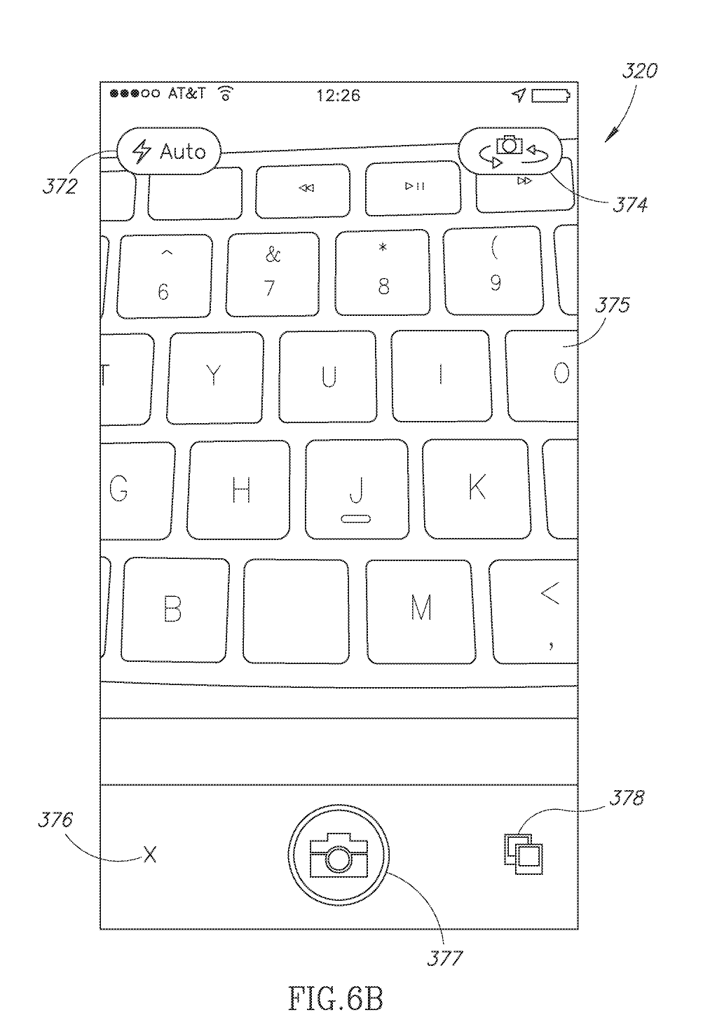

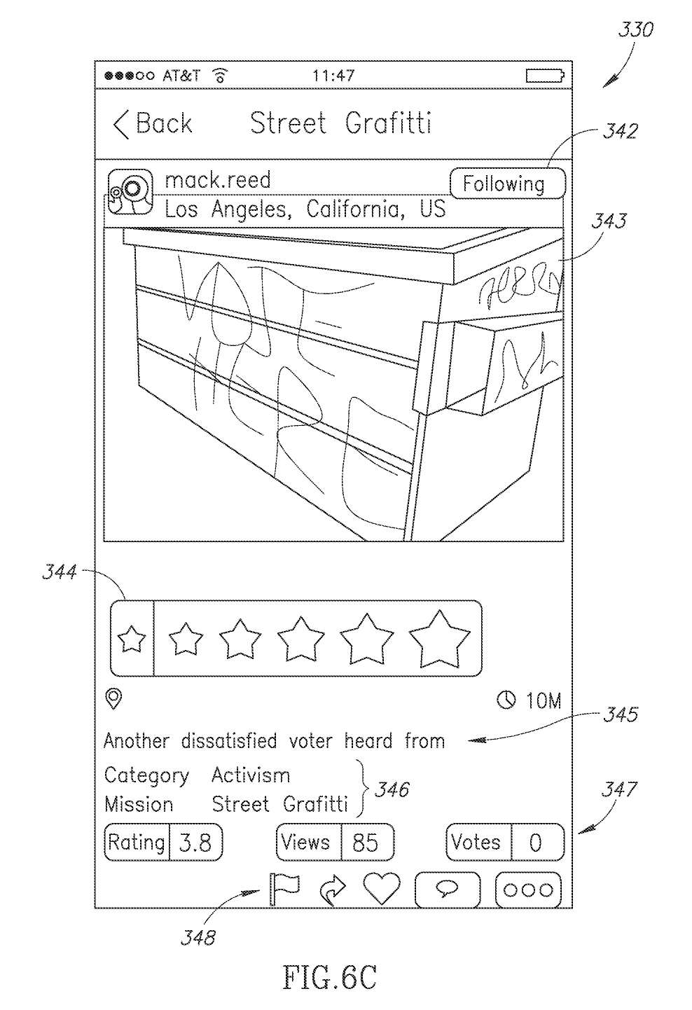

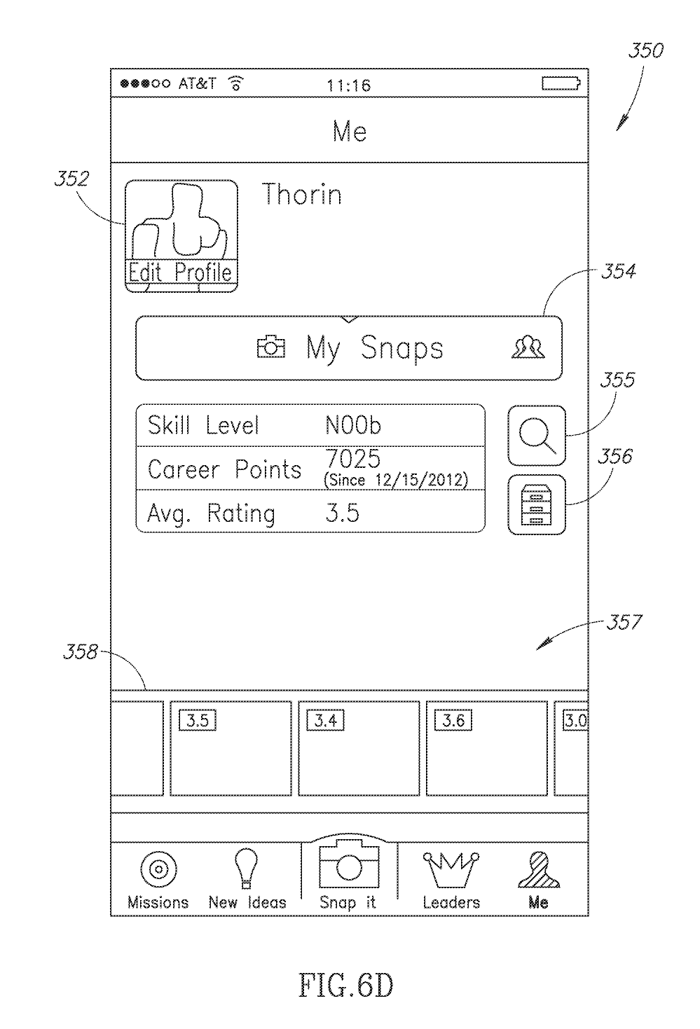

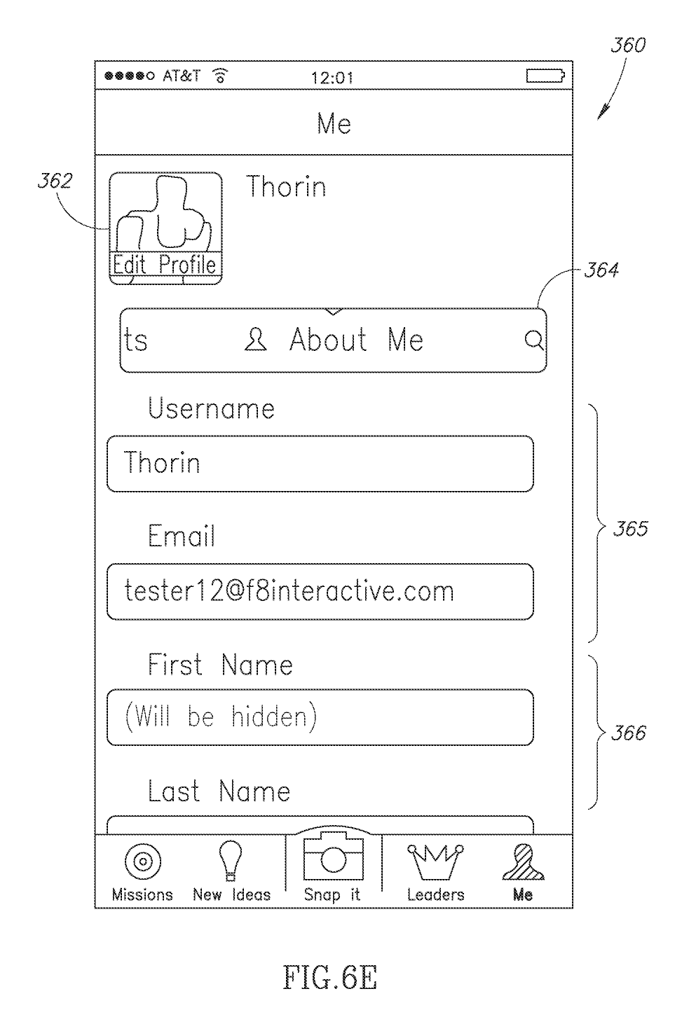

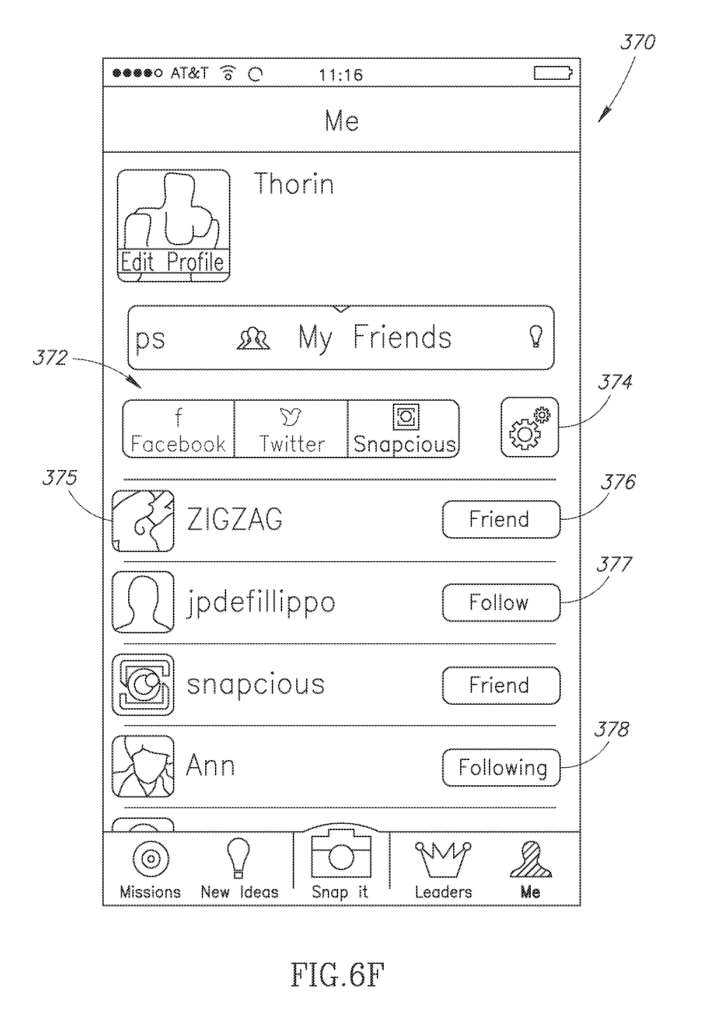

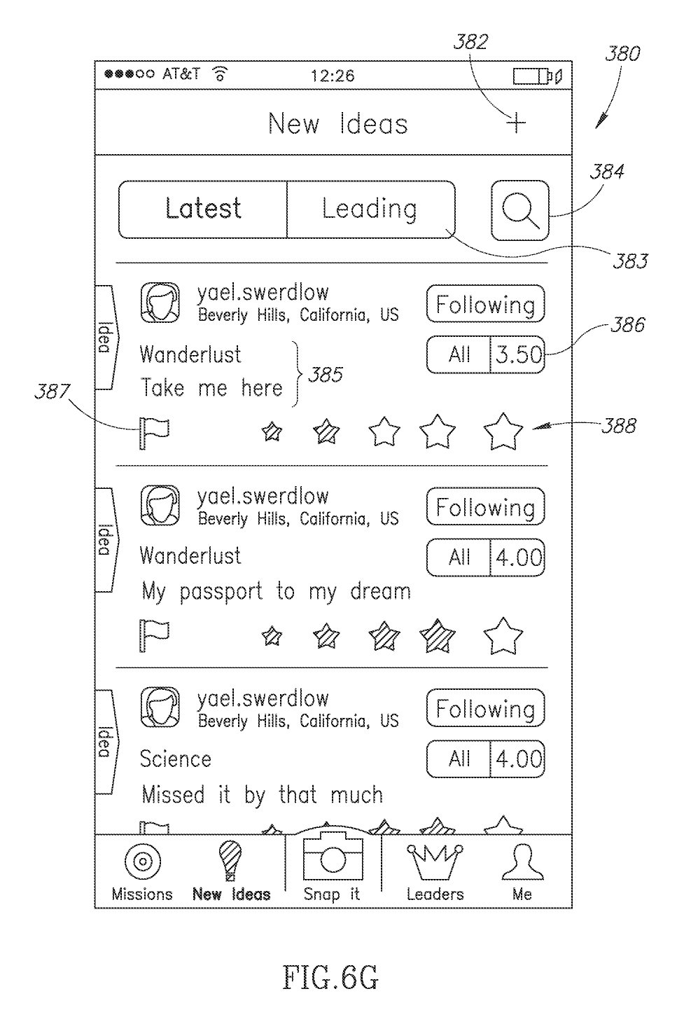

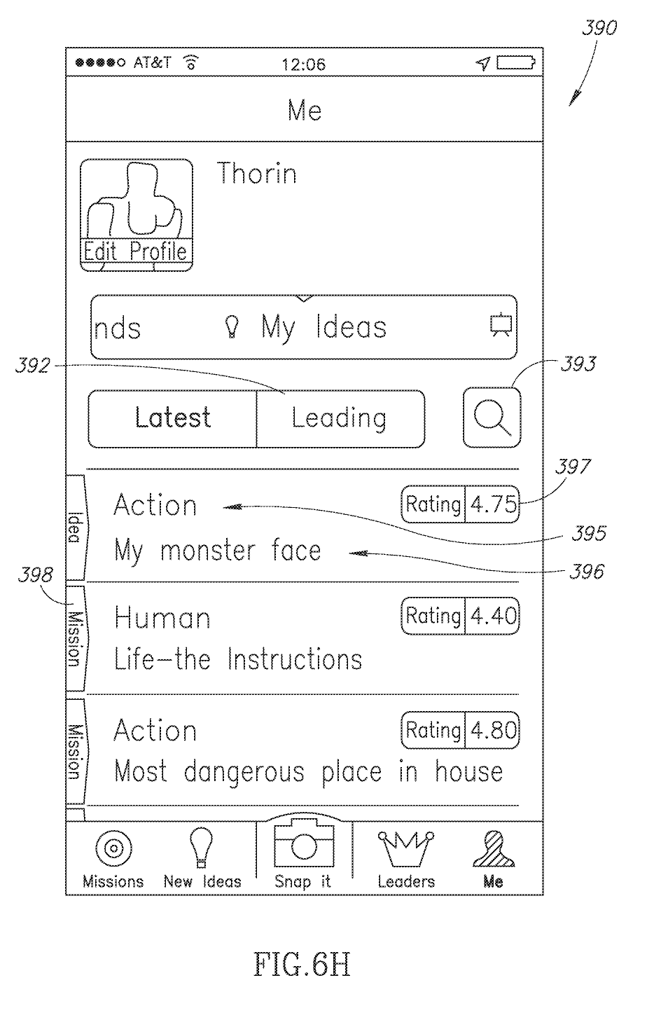

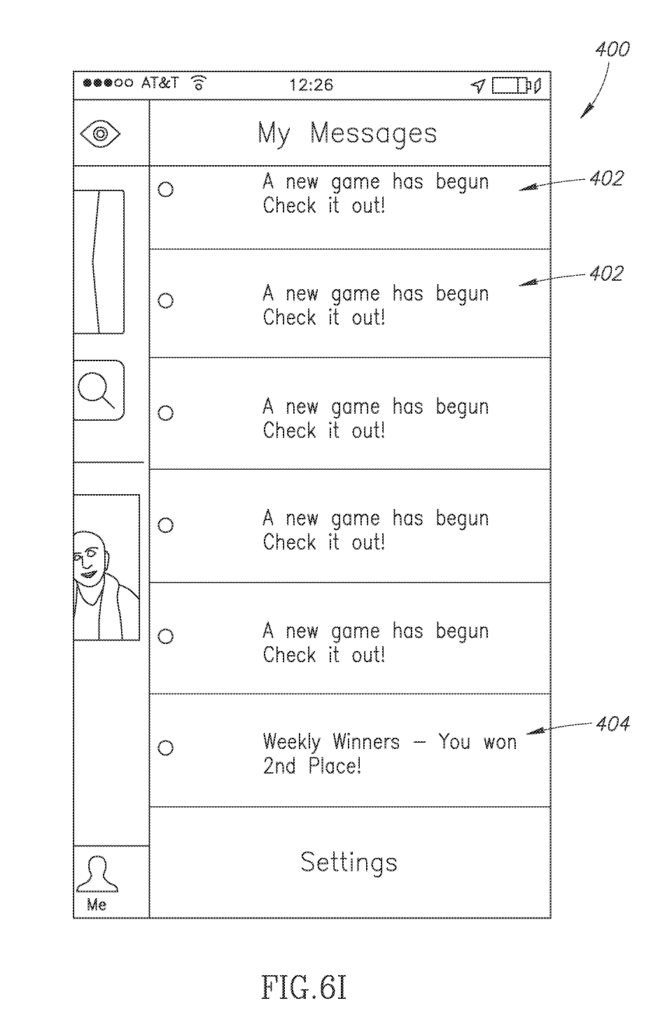

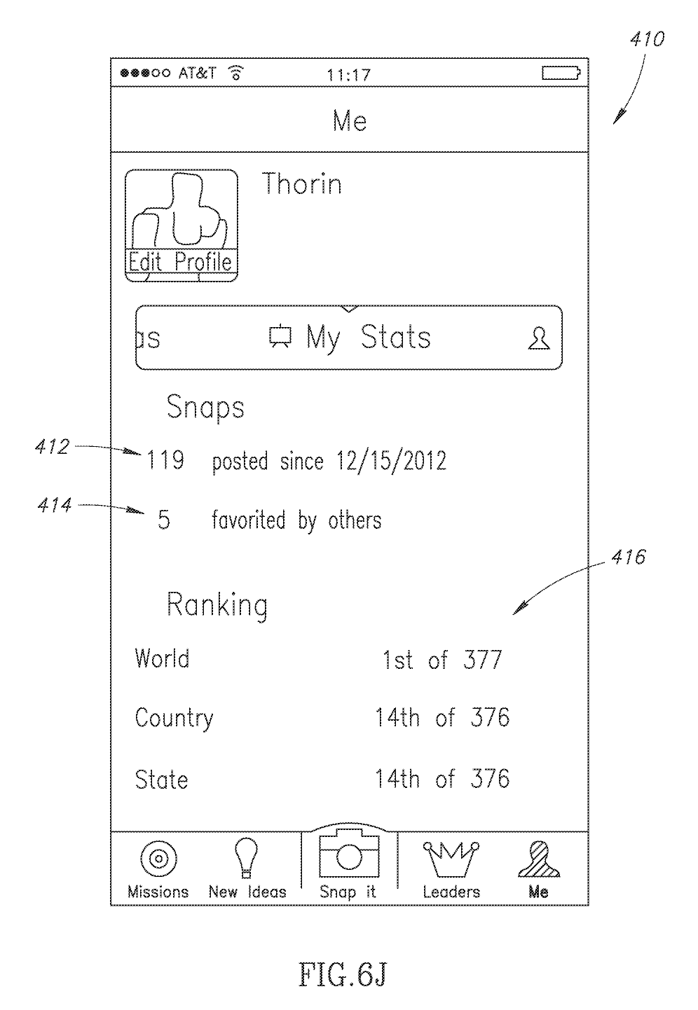

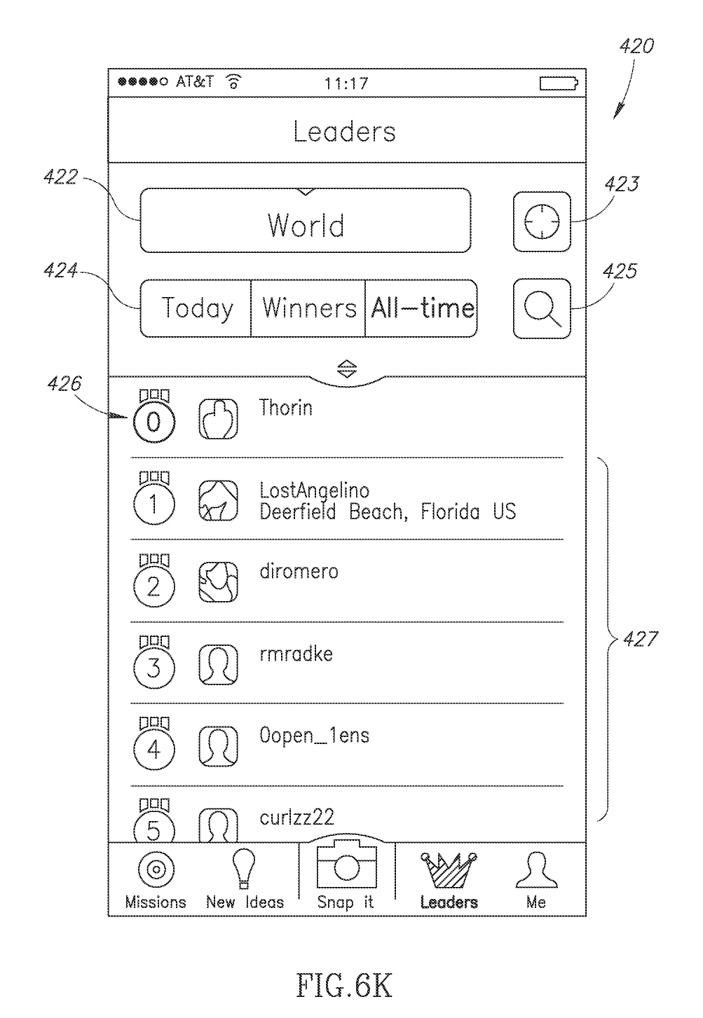

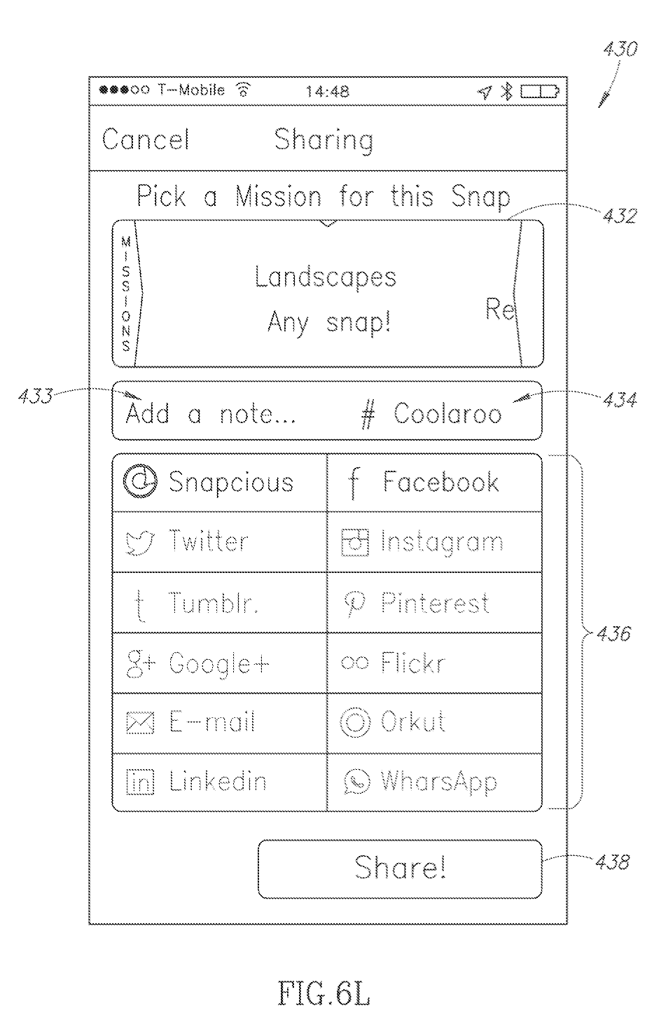

Referring to FIG. 2, the browse functionality may be displayed to one of the users U1-U5 by the client application 210 in a contest (or “mission”) interface 310 illustrated in FIG. 6A. Referring to FIG. 6A, the contest interface 310 shows contests and photographs that have been submitted to a particular contest. The contest interface 310 includes the following components:
(a) a control 312 that allows one of the users U1-U5 to select a particular contest to view and join;
(b) an optional category label 314 for this contest;
(c) contest text 315;
(d) an optional clock 316 that shows time remaining in this contest;
(e) an optional control 317 that allows a text search of contests, photographs and user profiles;
(f) a control 318 that launches a camera interface 320 illustrated in FIG. 6B.
(g) a thumbnail display 322 (illustrated as a scrollable array of thumbnails) that allows casual browsing and selection of photographs. In the embodiment illustrated, tapping on a thumbnail in the display 322 opens a selected photograph in a photograph view interface 330 illustrated in FIG. 6C.

### View/Rate/Comment/Love Functionality

Referring to FIG. 5A, the client application 210 is configured to interact with the web services 220 to provide view/rate/comment/love functionality. In the example illustrated, the client application 210 interacts with a scoring engine 250 that applies ratings to data objects, logs player activities, and awards points. The scoring engine 250 serves complex ratings to a leaderboard module 252.

The scoring engine 250 (e.g., implemented on the application instance computing devices 160 coupled to the RDS servers 140, 142, and 144) determines winners and runners-up in a particular contest, content category, time-period, or geographical location by tracking user activity. Referring to FIG. 4D, the scoring engine 250 may include a ratings module 254A, an activity-monitoring module 254B, and a scoring module 254C.

The ratings module 254A collects ratings that users apply to photographs submitted by other users via the client application 210, and collates those user-applied ratings to determine the top-ranked photographs in a contest, and the top-ranked user of the day. The ratings module 254A may be characterized as implementing a rating system. A customer (e.g., one of the brands B1 and B2) may use the rating system to adjust the ratio of photo-rankings against activity points that govern the way the scoring engine 250 determines winners and leaders to suit customer needs. The icons in a rating control 344 (described below) may be customized to suit customer needs.

The activity-monitoring module 254B awards activity points to a user every time that user takes a particular action. For example, activity points may be awarded to a user whenever that user posts a photograph and caption to the contest (or game), shares a photograph and caption to one or more of the external target networks 102, rates a photograph, comments upon a photograph, marks a photograph as “Loved,” gives a “thumbs-up” or “thumbs-down” to another user's content, submits a contest idea, and/or rates a contest idea.

The scoring module 254C determines a daily score and a weekly score for each of the users U1-U5 by first collating the user's content ratings and the user's activity points, and then applying a customizable formula to the user's content ratings and activity points to calculate the daily and weekly scores. For example, the formula may specify that average photograph ratings may count for 75% of the user's daily and weekly scores, and activity points may count for 25% of the user's daily and weekly scores. The scoring module 254C also calculates daily and weekly “winners” based on the daily and weekly scores determined for each user.

Referring to FIG. 2, the view/rate/comment/love functionality may be displayed to one of the users U1-U5 by the client application 210 in the photograph view interface 330 depicted in FIG. 6C. Referring to FIG. 6C, the photograph view interface 330 includes controls configured for the users U1-U5 to use to interact with a selected photograph. In the embodiment illustrated, the photograph view interface 330 includes the following components:
(a) a toggle 342 that allows one of the users U1-U5 to follow a user (e.g., Mack Reed) who created the selected (and displayed) photograph;
(b) a full-size view 343 of the selected photograph;
(c) the rating control 344 that allows one of the users U1-U5 to grant (or rate) the selected photograph (e.g., 1-5 stars);
(d) a user-generated caption 345;
(e) category/contest metadata 346;
(f) statistics 347; and
(g) controls 348 to flag inappropriate content, share photograph to other external target (e.g., social) networks, mark the photograph as “Loved,” post a comment, and collapse this view to show only (i) the selected photograph, (ii) the rating control 344, and (iii) the user-generated caption 345.

The icons displayed in the rating control 344 (e.g. 1-5 stars) may be customized to suit the needs of one of the brands B1 and B2.

### Profile Functionality

Referring to FIG. 5A, the client application 210 is configured to interact with the web services 220 to provide profile functionality. In the example illustrated, the client application 210 interacts with an identity module 256 that allows the users U1-U5 to read, write, and edit their user profiles.

Referring to FIG. 4A, the identity module 256 (see FIGS. 4D and 5A) may be implemented on the application instance computing devices 160 coupled with the RDS servers 140, 142, and 144. The identity module 256 allows a user to create and edit a profile that includes the following information: name/username; email address; geographic location; and user-applied metadata. The identity module 256 allows the user to upload an avatar to the profile, administer his/her credentials, control frequency and mode of system messaging, and control privacy.

Referring to FIG. 2, some of the profile functionality may be displayed to one of the users U1-U5 by the client application 210 in a user profile interface 350 depicted in FIG. 6D. Referring to FIG. 6D, the user profile interface 350 includes the following components:
(a) an edit profile control 352;
(b) a select other profile views control 354;
(c) a control 355 for searching for content associated with this user;
(d) a control 356 for filtering (e.g., by current, archived, highest-ranked, etc.) photographs 357 shown in the user profile interface 350; and
(e) a display area 358 for displaying the photographs 357, in which the photographs 357 are selectable and when selected are displayed full-size.

Referring to FIG. 2, some of the profile functionality may be displayed to one of the users U1-U5 by the client application 210 in a user metadata interface 360 depicted in FIG. 6E. Referring to FIG. 6E, the user metadata interface 360 includes the following components:
(a) an editable avatar 362;
(b) a control 364 for selecting other views;
(c) identity metadata 365; and
(d) personal metadata 366.

The user profile interface 350 and/or user metadata interface 360 may be configured to collect metadata from the users U1-U5 selected by one of the brands B1 and B2.

### Snap (or Image Capture) Functionality

Referring to FIG. 5B, the client application 210 is configured to provide snap (or image capture) functionality. Referring to FIG. 2, the snap (or image capture) functionality may be displayed to one of the users U1-U5 by the client application 210 in the camera interface 320 depicted in FIG. 6B. Referring to FIG. 6B, the camera interface 320 is configured to allow a user to capture a photograph. In FIG. 6B, the camera interface 320 is depicted capturing an image of a keyboard. As is appreciated by those of ordinary skill in the art, the components of the camera interface 320 illustrated in FIG. 6B are configured for use with a particular operating system (e.g., iOS). However, through application of ordinary skill in the art to the present teachings, the components of the camera interface 320 may be configured for use with other operating systems, such as Android operating system, Windows operating system, and the like. The camera interface 320 includes the following components:
(a) a standard camera flash control 372;
(b) a standard front/rear camera-select control 374;
(c) a camera view 374;
(d) a dismiss camera control 376;
(e) a shutter control 377;
(f) a launch browser control 378 for a user to use to select a photograph from a mobile device's onboard library (not shown).

### Post/Share Functionality

Referring to FIG. 5B, the client application 210 is configured to interact with the web services 220 to provide post/share functionality. The client application 210 includes a sharing module 262 configured to share information directly with the external target networks 102 (such as social media sites). The sharing module 262 allows each of the users U1-U5 to modify (or eliminate entirely) the number and type of social services to which the users can share photographs.

In the example illustrated, the client application 210 interacts with a publication module 258 (described below) that allows the users U1-U5 to publish content to a contest. The publication module 258 interacts with a media processing module 260 (described below) within the media/data storage 230.

Referring to FIG. 2, some of the post/share functionality may be displayed to one of the users U1-U5 by the client application 210 in a sharing interface 360 depicted in FIG. 6L. Referring to FIG. 6L, the sharing interface 430 includes the following components:
(a) a mission selection control 432;
(b) a caption form control 433 for launching a form into which a caption may be entered;
(c) automatically generated hashtag(s) 434;
(d) a network selection control 436 for selecting two or more of the external target networks 102; and
(e) a share control 438 that when actuated (e.g., tapped) shares the photograph, the user supplied caption, and the automatically added hashtag(s) with the selected ones of the external target networks 102 and, if selected, the platform 100. The photograph, the user supplied caption, and the automatically added hashtag(s) may also be shared with one or more websites (and/or web services) associated with or controlled by the brand that created the contest.

By default, the platform 100 may be selected in the network selection control 436. The control 436 may also be used to unselect a previously selected network.

### Friending Functionality

Referring to FIG. 5B, the client application 210 is configured to interact with the web services 220 to provide friending functionality. In the example illustrated, the client application 210 interacts with a social module 264 and a groups module 266 that allow the users U1-U5 to connect to friends, or assemble friends into groups for private contests.

Referring to FIG. 4A, the social module 264 (see FIGS. 4D and 5B) may be implemented on the application instance computing devices 160 coupled with the RDS servers 140, 142, and 144. The social module 264 allows users to “follow” each other, which allows such users to compare the ratings (or performance) of their photographs against their friends' photographs to determine whose photographs have the highest-rankings. The social module 264 allows users to “unfollow” each other, removing this connection. The social module 264 marks users following each other as “Friends.”

A groups module 266 may be implemented by the application instance computing devices 160 coupled with the RDS servers 140, 142, and 144. The groups module 266 allows users to create groups of users that may be used to administer private photograph contests among the members of the group.

Referring to FIG. 2, the friending functionality may be displayed to one of the users U1-U5 by the client application 210 in a friends interface 370 depicted in FIG. 6F. Referring to FIG. 6F, the friends interface 370 shows other users (and, for example, Facebook and Twitter friends) with whom this user is associated. The friends interface 370 includes the following components:
(a) a control 372 for showing friends in the external target networks 102 (e.g., Facebook, Twitter, etc.) or the platform 100 (labeled “Snapcious” in FIG. 6F;
(b) a control 374 for hiding or showing a user's list of friends on the platform 100 to other users;
(c) an avatar 375 for each of the other users;
(d) a control 376 that may be tapped to un-friend another user;
(e) a control 377 that may be tapped to follow another user; and
(f) an indicator 378 that shows status (e.g., “following”) of another user who has not followed the user for whom the friends interface 370 is being displayed.

### Ideas Functionality

Referring to FIG. 5C, the client application 210 is configured to interact with the web services 220 to provide ideas functionality. In the example illustrated, the client application 210 interacts with a contest rotation module 268 that allows the users U1-U5 to suggest and rate ideas. The platform 100 determines winners for each contest and creates a next contest from top-ranked ideas.

Referring to FIG. 4A, the contest rotation module 268 (see FIGS. 5C and 4D) may be implemented on the application instance computing devices 160 coupled with the RDS servers 140, 142, and 144. The contest rotation module 268 allows users to submit ideas for future contests and rate them. Further, the contest-rotation module 268 may automatically serve the top-rated idea as the next contest. The contest-rotation module 268 may also serve “winning” photographs at the end of each contest (in tandem with the scoring engine)

Referring to FIG. 2, some of the ideas functionality may be displayed to one of the users U1-U5 by the client application 210 in a new ideas interface 380 depicted in FIG. 6G. Referring to FIG. 6G, the new ideas interface 380 shows contest ideas submitted by users. The new ideas interface 380 includes the following components:
(a) a control 382 that launches a form allowing the user to submit a contest idea;
(b) a control 383 that allows the user to sort ideas displayed (in the view) to show latest-posted or top-ranked ideas;
(c) a control 384 that allows full-text search of ideas;
(d) metadata 385 that shows static category and user-submitted contest idea;
(e) a display area 386 showing current rating of this idea;
(f) a control 387 that allows the user to flag this idea as inappropriate content; and
(g) a control 388 (e.g., a sControl) that allows the user to rate this idea (e.g., from one to five stars).

Referring to FIG. 2, some of the ideas functionality may be displayed to one of the users U1-U5 by the client application 210 in a user ideas interface 390 depicted in FIG. 6H. Referring to FIG. 6H, the user ideas interface 390 generally shows all contest ideas submitted by this user, including those that were highly-ranked and became contests. The user ideas interface 390 includes the following components:
(a) a control 392 for sorting ideas;
(b) a control 394 for searching ideas;
(c) text 395 identifying the category;
(d) text 396 identifying or describing the idea;
(e) a rating indicator 397; and
(f) a status indicator 398 indicating that an idea became a contest.

### Messages Functionality

Referring to FIG. 5C, the client application 210 is configured to interact with the web services 220 to provide messages functionality. In the example illustrated, the client application 210 interacts with a messaging module 270 that allows the platform 100 to send messages to the users U1-U5 about new games. Such messages may include a final ranking of their photographs, game ranking, and comments from other users.

Referring to FIG. 4A, the messaging module 270 (see FIGS. 4D and 5C) may be implemented on the application instance computing devices 160 coupled with the RDS servers 140, 142, and 144. The messaging module 270 may notify users via a variety of methods, including, for example, in-app notifications, in-device notifications, and email. The notifications may notify users of the winning photos from each contest and/or winning users for each day or week. The notifications may notify a particular user that comments have been posted by other users with respect to the particular user's content, and/or photographs posted by the particular user have been marked as “Loved” by other users. The messaging module 270 allows customers to adjust the method, frequency, and content of system messages in the client application 210, the mobile platform, or the web services 220 to suit the needs of one of the brands B1 and B2.

Referring to FIG. 2, some of the messages functionality may be displayed to one of the users U1-U5 by the client application 210 in a message interface 400 depicted in FIG. 6I. Referring to FIG. 6I, the message interface 400 displays (a) notifications 402 of new contests, and (b) notifications 404 of the user's recent wins.

Referring to FIG. 2, some of the messages functionality may be displayed to one of the users U1-U5 by the client application 210 in a user stats interface 410 depicted in FIG. 6J. Referring to FIG. 6J, the user stats interface 410 includes the following components:

(a) an indicator 412 of a number of photographs (“snaps”) submitted to contests in this instance of the platform 100;

(b) an indicator 414 of a number of photographs “Loved” or favorited by others

(c) indicators 416 of current rankings by world, country, state/province/prefecture, city, and category

### Leaderboard Functionality

Referring to FIG. 5C, the client application 210 is configured to interact with the web services 220 and the media/data storage 230 to provide leaderboard functionality. In the example illustrated, the client application 210 interacts with a search module 272 (described below) that allows the users U1-U5 to query latest rankings (served by the contest-rotation module 268 and the scoring engine 250) by geography, friends, etc.

Referring to FIG. 4A, the search module 272 (see FIGS. 4D and 5C) may be implemented on the application instance computing devices 160 coupled with the RDS servers 140, 142 and 144. The search module 272 allows users to use a simple interface to perform complex queries on the database of content and user profiles. These queries may be used to finding specific photos, captions, or users. Further, the queries may be used to find specific contests or parse a leaderboard created and maintained by the leaderboard module 252.

Referring to FIG. 4A, the leaderboard module 252 (see FIG. 4D) may be implemented on the application instance computing devices 160 coupled with the RDS servers 140, 142 and 144. The leaderboard module 252 identifies and displays the top-ranked photographs and top-ranked users through a variety of user-controlled filters. For example, the users U1-U5 may view the best photographs and/or users by filtering photographs by contest category and/or specifying a geographic location, nation, state/province/prefecture, and/or city. Further, a user may filter photograph by world, friends-only, or all users.

Referring to FIG. 2, the leaderboard functionality may be displayed to one of the users U1-U5 by the client application 210 in a leaderboard interface 420 depicted in FIG. 6K. Referring to FIG. 6K, the leaderboard interface 420 shows all players ranked by a variety of filters, the default being “World.” The leaderboard interface 420 includes the following components:
(a) a control 422 that allows the user to filter a display of top-ranked users by world, the user's nation, the user's state/prefecture/province, the user's city, or the user's friends;
(b) a control 423 for selecting one or more specific locations (e.g., one or more cities) in which this user does not live;
(c) a control 424 for time-sorting users;
(d) a control 425 that launches a full-text search for users by user name;
(e) a display region 426 showing the user's current status in this sort (determined by the controls 422-425); and
(f) a display region 427 showing other users in order of ranking by the parameters chosen using at least one of the controls 422-425.

The filters used to generate the leaderboard displayed by the leaderboard interface 420 (geography, category) may be customized based on values or information collected in user profiles.

As described above, FIGS. 6A-6K depict interfaces 310, 320, 330, 350, 360, 370, 380, 390, 400, 410, and 420, respectively, that are integrated into the client application 210 (and displayable by each of the client computing devices 170), and enable the users' principal interactions with the platform 100. The client application 210 displays a visual framework and branding elements that may be customized to suit the needs of one of the brands B1 and B2.

### Additional Functionality

Referring to FIG. 4D, a content-moderation (flagging) module 276 may be implemented on the application instance computing devices 160 coupled with the RDS servers 140, 142, and 144. The content-moderation (flagging) module 276 allows users to flag photographs, user profiles, or user-generated text as inappropriate for reasons such as obscenity, copyright violation, terms of use (“TOU”) violation, etc. As explained above, one of the users U1-U5 may identify content (e.g., a photograph) as inappropriate using one of the controls 348 (see FIG. 6C) of the photograph view interface 330 (see FIG. 6C). Similarly, one of the users U1-U5 may identify an idea as inappropriate using the control 387 (see FIG. 6G) of the new ideas interface 380 (see FIG. 6G).

The content-moderation (flagging) module 276 automatically hides flagged content from public view in the platform 100. Further, the content-moderation (flagging) module 276 automatically hides feeds (from public view in the platform 100) that supply content that has been flagged after a predetermined and administrator-configurable number of user-applied flags have been reached. Custom thresholds may be set for the number of content flags required for the platform 100 to automatically hide a piece of content. Further, the content-moderation (flagging) module 276 automatically ejects a user from the platform 100 after a predetermined and administrator-configurable number of content items supplied by the user have been hidden by user-flagging. Custom thresholds may be set for the number of hidden-content objects required for the platform 100 to automatically eject a user.

An administrative module 278 may be implemented on the application instance computing devices 160 coupled with the RDS servers 140, 142, and 144. The administrative module 278 allows system administrators to review flagged content, ejected users, remove flags to un-hide content, hide flagged content manually if it has not received enough flags to hide it automatically, eject users manually if their hidden content has not yet reached the predetermined ejection threshold, and restore platform access to ejected users.

The platform 100 implements several unique data objects which include a photo data object, a profile data object, a category data object, a contest data object, and a group data object.

The photo data object is a user-generated object created as an entry in a contest. The photo data object includes or links to the user-generated photograph (full size), a thumbnail version of the photograph, a user-generated caption, one or more system-configured hashtags.

The profile data object is a representation of a user, the user's content, and the user's gameplay records. The profile data object includes or links to an avatar image, identity metadata, identification information (e.g., first/Last name), an email address, a home location (Nation, state/province/prefecture, city), user-applied metadata (e.g., personal tastes, brand affinities, accomplishments, etc.), account credentials (e.g., password and username), contest statistics (e.g., number and nature of contest “wins”), photographs created by this user, and photographs created by others that are “Loved” by this user. A win generally signifies any time that a user's photograph was ranked first through tenth place.

The category data object is used to group contests thematically. The category data object includes or links to a text label and contests associated with this category.

The contest data object stores or represents the challenge submitted to the users U1-U5 and the photographs they submitted in response to the challenge. The contest data object includes or links to text, start time, end time, hashtags, and photographs posted to the contest. The start and end times may be used to create or control a game clock. The length of a contest may be customized per the desires of one of the brands B1 and B2.

The group data object stores or represents a collection of eight or more users gathered by a single user for purposes of competing in contests solely amongst themselves. The group data object includes or links to a text label, and users associated with the group data object.

### Methods

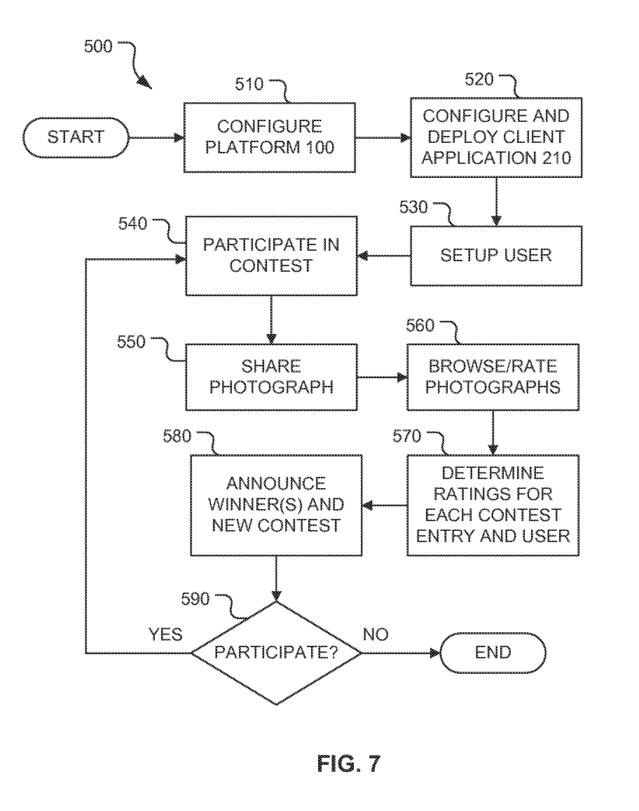

FIG. 7 is a flow diagram of an exemplary method 500 of collecting and distributing photographs using crowdsourcing. In first block 510, an instance of the platform 100 is configured for use. Referring to FIG. 4A, this may include configuring the back-end architecture and deploying the back-end architecture to various servers (e.g., the load balancers 110, the memcached servers 120, the image-processing servers 130, the content storage 150, and the relational-database servers, which may include the application database server 140, the configuration database server 142, and the website database server 144).

Referring to FIG. 7, in next block 520, the client application 210 is configured and deployed to the mobile-application publication platform 212 (see FIG. 2) for distribution to the client computing devices 170 operated by the users U1-U5.

In block 530, one of the users U1-U5 is setup to use the platform 100. For ease of illustration, the user U1 will be described as being setup to use the platform 100. The user U1 downloads and installs the client application 210 on the client computing device 170A (e.g., a mobile device) and creates a user profile (e.g., using the user profile interface 350 depicted in FIG. 6D). The platform 100 creates a profile data object to represent the user U1, the user's content, and the user's gameplay records.

In block 540, the user U1 participates in a contest. During contest participation, the user U1 views one or more contests (e.g., using the contest interface 310 depicted in FIG. 6A), selects a contest, and uses the client application 210 (e.g., implemented on the client computing device 170A) to author a photograph, enter text that might describe it, and post both the photograph and the text as a photo data object to the selected contest (or game). Each contest is represented by a different contest data object. Each contest data object may be associated with a category data object.

In block 550, the user U1 shares the photograph with two or more of the external target networks 102. During the sharing activity, the user U1 may elect to publish the photo data object (or the information stored therein) to any of the plurality of available social networks (e.g., Facebook, Instagram, etc.).

In block 560, the users U1-U5 browse and/or rate photographs (e.g., using the contest interface 310 depicted in FIG. 6A and the photograph view interface 330 depicted in FIG. 6C). During the browsing/rating activity, other users may browse the photograph and all photographs posted by the users U1-U5 to the selected contest and other contests made available within the client application 210. The other users may apply a subjective rating (for example, 1-5 stars or other tokens, with one being least-apt and five being most-apt for matching the challenge outlined in the contest). Additional interactions may also be available. For example, the other users may post text comments on all of the photographs. Additionally, a user may post comments on his/her own photographs. Further, other users may tag photographs as “Loved.”

In block 570, the scoring engine 250 determines a rating for each contest entry and makes that rating available to the users U1-U5. The scoring engine 250 keeps track of average ratings on each photograph, (as well as user-actions such as posting, rating, and commenting on photographs) and makes this metadata available on both the photo data objects (e.g., via the photograph view interface 330 depicted in FIG. 6C) and the leaderboard interface 420 depicted in FIG. 6K. Users may view the leaderboard interface 420 to determine the rating of their photographs, and their own current ranking as users (as determined by the scoring engine 250). The users may use the search module 272 (see FIGS. 4D and 5C) to view player rankings and compare these rates to those received by others using a variety of filters, which allow a user to see how he/she is ranked against other users in his/her group of friends, or against other users within a particular geographic region (e.g., a city, state/province, or nation) where the user lives, or against all users worldwide. The search module 272 also allows a user to see how he/she is ranked against others in the current contest, or among others authoring content in the same overarching category.

In block 580, the platform 100 announces the winner(s) of the contest. As mentioned above, users may use the client application 210 to post new ideas for future contests to the platform 100 and other users may apply ratings to these ideas. At the end of a particular contest, the contest rotation module 268 (see FIGS. 5C and 4D), announces the winning photographs and users via the messaging module 270 (see FIGS. 5C and 4D), feeds this information as metadata to the scoring engine 250, transforms the highest-ranked idea into the next contest, and notifies all of the users of the past-contest activity (wins, ranking, etc.) and of the new contest.

In decision block 590, a user decides whether to participate in the new contest or a different contest. The decision in decision block 590 is “YES,” when a particular user decides to participate in the new contest or a different contest. When the decision in decision block 590 is “YES,” the user returns to block 540. On the other hand, the decision in decision block 590 is “NO,” when a particular user decides not to participate in the new contest or a different contest. When this is the case, the method 500 terminates.

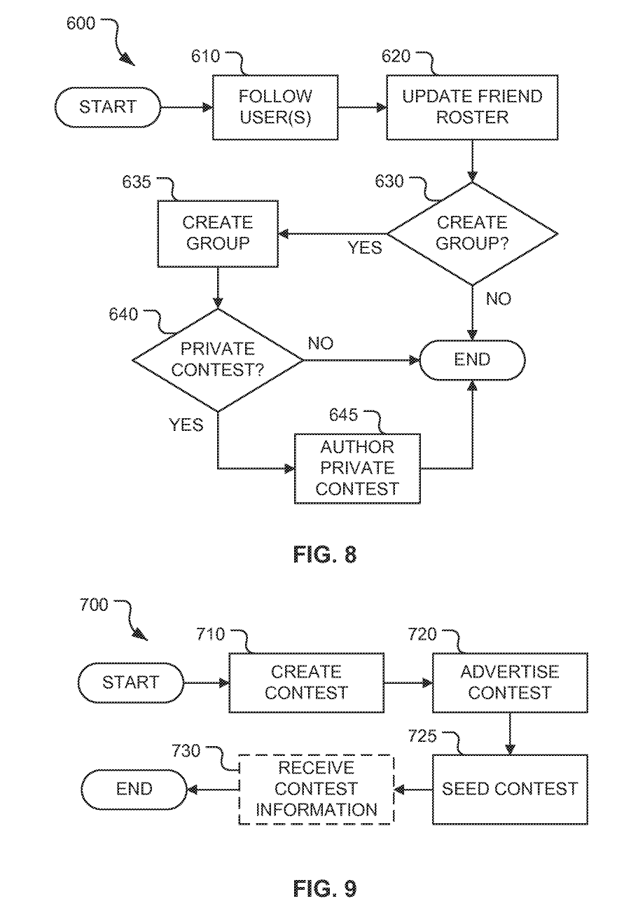

The platform 100 also implements social activities. FIG. 8 is a flow diagram of a method 600 for implementing such social activities. In first block 610, a user follows one or more other user's accounts. For example, the user may use the friends interface 370 (see FIG. 6F) to follow one or more other users.

In block 620, the platform 100 puts those users being “followed” into a “Friends” roster in the “following” user's profile, as well as in the “Friends” filter of the leaderboard interface 420 (see FIG. 6K). Essentially, this allows the users U1-U5 to vie against other users identified as “friends” in photograph contests.

In decision block 630, the user decides whether to create or define a group of friends. The decision in decision block 630 is “YES,” when the user decides to create a group of friends. On the other hand, the decision in decision block 630 is “NO,” when the user decides not to create a group of friends.

When the decision in decision block 630 is “YES,” in block 635, the user collects a number of friends (e.g., seven or more) into a group. Each user may edit the membership of any groups created by the user. A different group data object stores or represents each group created by the user.

Then, in decision block 640, the user decides whether to author a private contest. The decision in decision block 640 is “YES,” when the user decides to author a private contest. On the other hand, the decision in decision block 640 is “NO,” when the user decides not to author a private contest.

When the decision in decision block 640 is “YES,” in block 645, the user authors a private contest, which allows allowing the user to compete solely amongst members of the group. After a private contest has been authored, the method 600 terminates. After the method 600 terminates, the messaging module 270 (see FIGS. 4D and 5C) may send a message to each member of the group announcing the private contest. Then, the private contest may be implemented using blocks 540-580 of the method 500 illustrated in FIG. 7.

The platform 100 and the methods 500 and 600 may be configured to serve businesses (e.g., the brands B1 and B2) by performing one or more of the following functions:
Aggregating user-generated content around contest material authored by a customer (or brand);
Publishing the aggregated content to multiple ones of the external target networks 102 (e.g., social networks);
Aggregating user-generated photographs around specific locations; and
Aggregating user-generated photographs of specific (planned and unplanned) events.

Further, the platform 100 and the methods 500 and 600 may be used to market goods, services, events, or other business products. As explained above, the platform 100 may be configured to provide the following functionality:
Automatic hash-tagging of photographs;
Automatic calculation and determination of winners;
Sharing of the data objects to multiple (e.g., ten) ones of the external target networks (e.g., social networks); and
Automatic sending of notifications to the users regarding new contests.

FIG. 9 is a flow diagram of a method 700 performed by one of the brands B1 and B2 (see FIG. 2) operating one of the customer computing systems 104 (see FIG. 2). For ease of illustration, a version of the platform 100 will be described as being deployed for the brand B1, which will be described as being a clothing manufacturer having the fictitious name “Coolaroo.”

In first block 710, the brand B1 creates one or more contests by providing contest information (e.g., one or more descriptions of a charge or theme) to the platform 100. As explained above, the platform 100 is configured to create contests based on direct input from the brand B1. By way of examples, the brand B1 may create two contests having the following themes: “My Coolaroo skirt matches all my shoes,” or “My hottest Coolaroo nightclub outfit.”

Then, in block 720, the brand B1 publishes notices of the photograph contests using its own advertising methods. These notices provide a URL for downloading the client application 210 (onto the client computing devices 170). The client application 210 displays the contests (e.g., in the contest interface 310 illustrated in FIG. 6A) for the brand B1.

Meanwhile, in block 725, the brand B1 “seeds” the contests by using the client application 210 (executing on the client computing devices 170) to publish a few sample photographs answering (or in response to) the themes of the contests to help incoming consumers (or users) understand the contests.

In optional block 730, the brand B1 receives contest information (e.g., content, identifications of winners, CRM data, user information, etc.). The contest information may be received by the customer computing system 104A, one or more websites (and/or web services) associated with or controlled by the brand B1. The recipient(s) of contest information may display at least some of the information received.

Then, the method 700 terminates.

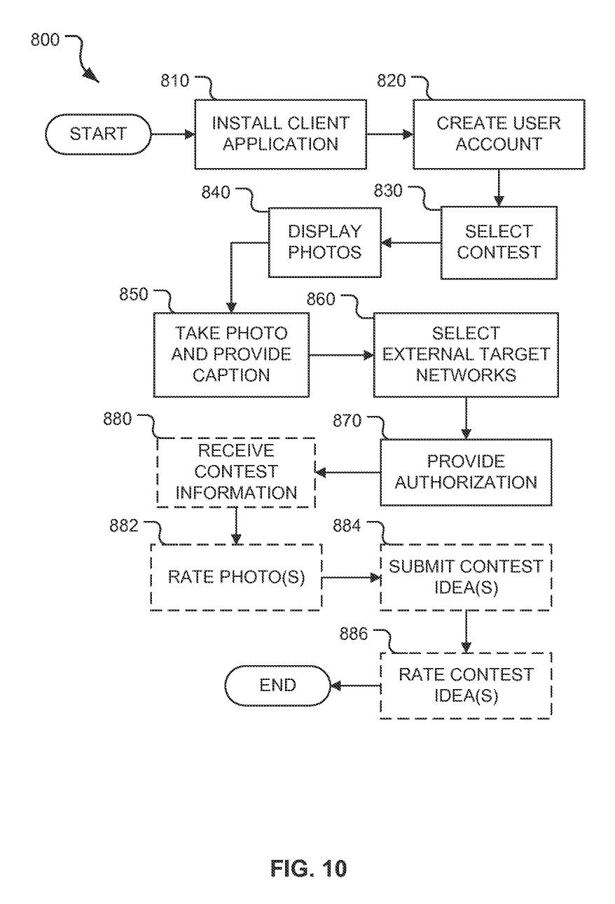

FIG. 10 is a flow diagram of a method 800 performed by one of the users U1-U5 (referred as consumers) operating one of the client computing devices 170. For ease of illustration, the method 800 will be described as being performed by the user U1.

In first block 810, after viewing the notice published by the brand B1 (in block 720 of the method 700 illustrated in FIG. 9) or a photograph submitted to the contest by another user (e.g., the user U2) and posted to one of the external target networks 102 or the platform 100, the user U1 visits the URL advertised in the notice and downloads the client application 210 to the client computing device 170A operated by the user U1. Thus, in block 810, the client computing device 170A receives a copy of the client application 210 and executes it.

In next block 820, the user U1 registers with the platform 100 and creates a user account using the client application 210. During this process, the user U1 may provide user profile information via the user profile interface 350 (depicted in FIG. 6D) and the user metadata interface 360 (depicted in FIG. 6E). By way of a non-limiting example, the client application 210 may include a Facebook Connect authentication mechanism that can be used to create the user account. Thus, in block 820, the client computing device 170A receives registration information (e.g., profile information) and transmits the registration information to the platform 100.

In block 830, the user U1 browses the various descriptions of themes (or contest prompts) in the client application 210 and selects one of the contests. For example, the user U1 may select the contest associated with the theme “My hottest Coolaroo nightclub outfit.” Thus, in block 830, the client computing device 170A receives contest information from the platform 100, displays the contest information to the user U1, and receives an identification of the user's selection that the client computing device 170A transmits to the platform 100.

In block 840, the client application 210 displays at least some of the photographs (including those seeded in block 725 of the method 700 illustrated in FIG. 9) that have been submitted so far to this contest to the user U1 in the contest interface 310 depicted in FIG. 6A.

In block 850, the user U1 uses the client computing device 170A and the client application 210 (e.g., the camera interface 320 depicted in FIG. 6B) to take a photograph and provide a caption (or text description). For example, in block 850, the user U1 may take a self-portrait wearing Coolaroo brand clothes, and add a text description (e.g., “These pants say ‘I came to dancer’”). In block 850, the client computing device 170A transmits the photograph and caption to the platform 100 as a contest submission.

In block 860, the user U1 uses the client computing device 170A and the client application 210 (e.g., the sharing interface 430 depicted in FIG. 6L) to select two or more of the external target networks 102 (e.g., Facebook, Instagram, and Pinterest) on which to share (or post) the photograph captured in block 850. In block 860, the client computing device 170A transmits these selections to the platform 100 as network selections.

In block 870, the user U1 receives a prompt from the platform 100 (via the client application 210) to authorize the user's accounts with the external target networks 102 selected in block 860 to use the output from the client application 210. In response to the prompt, the user U1 provides authorization, which the client application 210 transmits to the platform 100. For example, the user U1 may authorize three of the external target networks 102 (e.g., Facebook, Instagram, and Pinterest).

In optional block 880, the user U1 receives contest information (via the client application 210) from the platform 100 (e.g., messages sent by the messaging module 270 depicted in FIGS. 4D and 5C). The client application 210 may display at least some of the contest information to the user U1 in the message interface 400 depicted in FIG. 6I. The contest information may include notification of the winner(s) of the contest.

In block 882, the user U1 may rate one or more photographs submitted by other users (e.g., using the contest interface 310 and the photograph view interface 330 depicted in FIGS. 6A and 6C, respectively). In block 882, the client computing device 170A transmits any user supplied ratings to the platform 100 as photograph ratings.

In optional block 884, the user U1 may submit one or more contest idea (or theme) (e.g., using the new ideas interface 380 depicted in FIG. 6G). In block 884, the client computing device 170A transmits any user supplied contest ideas to the platform 100. As mentioned above, other users may rate user supplied contest ideas and the platform 100 may send information related to these user ratings to the user U1 (e.g., via the message interface 400 depicted in FIG. 6I, the new ideas interface 380 depicted in FIG. 6G, and/or the user ideas interface 390 depicted in FIG. 6H).

In optional block 886, the user U1 may rate one or more contest ideas submitted by other users (e.g., using the new ideas interface 380 depicted in FIG. 6G). Then, the client computing device 170A transmits any user supplied ratings to the platform 100 as contest idea ratings.

While depicted as occurring after the block 880, the blocks 882-886 may occur at any time after block 882. Further, the blocks 882-886 may occur in any order and may be repeated.

Then, the method 800 terminates.

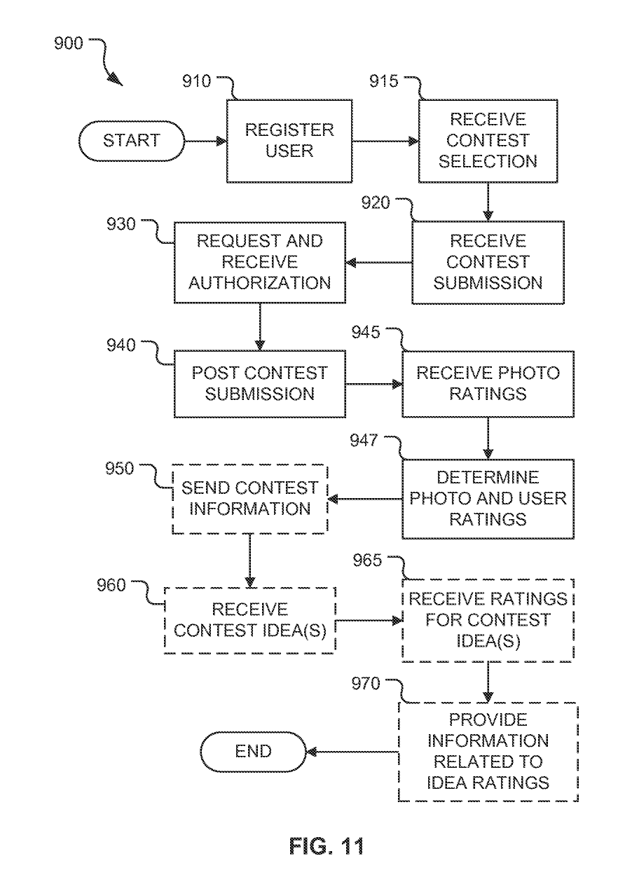

FIG. 11 is a flow diagram of a method 900 performed by the platform 100 communicating with the client application 210. Before the method 900 begins, the platform 100 has started one or more contests. For example, the platform 100 may have started a contest based on the contest information provided to the platform in block 710 of the method 700 depicted in FIG. 9. Each of the contests started by the platform 100 ends at an end time associated with the contest.

Referring to FIG. 11, in first block 910, the platform 100 receives the registration information sent by the client application 210 executing on the client computing device 107A in block 820 of the method 800 (see FIG. 10) and creates a user account for the user U1 thereby registering the user.

In block 915, the platform 100 sends contest information to the client computing device 170A (that the client computing device 170A receives and displays to the user U1) and receives an identification of a contest selected by the user U1 and transmitted to the platform 100 by the client computing device 170A.

In block 920, the platform 100 receives the contest submission transmitted by the client computing device 170A in block 850 of the method 800 illustrated in FIG. 10. As mentioned above, the contest submission includes a photograph and caption.

In block 930, the platform 100 receives the network selections transmitted by the client computing device 170A in block 860 of the method 800 illustrated in FIG. 10, sends the prompt received by the client computing device 170A in block 870 of the method 800 illustrated in FIG. 10, and in response to the prompt, receives the authorizations sent by the client computing device 170A in block 870 of the method 800 illustrated in FIG. 10. Thus, at this point, the platform 100 is authorized to post the contest submission to the networks selected by the user U1 in block 860 of the method 800 illustrated in FIG. 10.

In block 940, the platform 100 posts the contest submission to the selected networks and on the platform 100. Along with the contest submission, the platform 100 may post one or more custom hashtags and/or the URL from which a copy of the client application 210 may be downloaded. For example, in block 940, the platform 100 may attach custom hashtags “#Coolaroo #HotClubbingCoolaroo” and the URL from which a copy of the client application 210 may be downloaded to a combined photo/text data object. Then, the platform 100 may publish the combined data object to the contest “My Hottest Coolaroo Nightclub outfit” on the platform 100 (and displayed in the client application 210) as well as the Facebook, Instagram and Pinterest accounts of the user. The download URL is provided to encourage others to join the contest.

In block 945, the platform 100 receives any ratings submitted by other users for the photograph posted in block 940.

In block 947, the platform 100 determines the ratings for the photograph and user described above with respect to block 570 of the method 500 depicted in FIG. 7.

In optional block 950, the platform 100 may send the contest information received by the client application 210 in optional block 880 of the method 800 depicted in FIG. 10 to the client computing system 170A operated by the user U1. The platform 100 may send the contest information after the contest has ended and/or during the contest. In optional block 950, the platform 100 may send the contest information received by the brand B1 in optional block 730 of the method 700 depicted in FIG. 9 to the customer computing system 104A operated by the brand B1.

In optional block 960, the platform 100 may receive new contest ideas from the user U1 (submitted in optional block 884 of the method 800 depicted in FIG. 10).

In optional block 965, the platform 100 may receive ratings for the new contest ideas (submitted in optional block 886 of the method 800 depicted in FIG. 10).

In optional block 970, the platform 100 provides information to the user U1 (via the client application 210) regarding any new contest ideas submitted by the user U1 in optional block 884 of the method 800 depicted in FIG. 10. This information may be displayed to the user U1 in the message interface 400 depicted in FIG. 6I, the new ideas interface 380 depicted in FIG. 6G, and/or the user ideas interface 390 depicted in FIG. 6H).

While depicted as occurring after the block 950, the blocks 960-970 may occur at any time after block 910.

Then, the method 900 terminates.

The posting of the contest submission in block 940 attracts the attention of friends of the user U1 on those of the external target networks 102 selected by the user U1 in block 860 of the method 800 illustrated in FIG. 10. For the purposes of illustration, the users U3-U5 will be described as being friends of the user U1. For example, the user U3 follows the user U1 on Facebook, the user U4 follows the user U1 on Instagram, and the user U5 follows the user U1 on Pinterest.

Each of the users U3-U5 sees the post on the respective external target network 102 on which the users U3-U5 follow the user U1. Then, each of the users U3-U5 performs the method 800 depicted in FIG. 10. Thus, each of the users U3-U5 visits the URL and downloads and installs the client application 210 on the client computing devices 170C-107E, respectively. Further, each of the users U3-U5 creates a user account, and (individually) view the photograph submitted by the user U1 (in the contest submission submitted to the platform 100 in block 850 of the method 800 illustrated in FIG. 10), rate the photograph (e.g., using a scale of 1-5 stars), and submit photographs of their own to any of the contests provided by the copies of the client application 210 executing on the client computing devices 170C-107E, respectively.

Meanwhile, other consumers (unrelated to the users U1-U5) download copies of the client application 210 (to each of their computing devices like the client computing devices 170), create accounts, and submit photographs to the platform 100. All consumers may comment on, rate, and share each other's photographs via the external target networks 102. These activities earn each of the consumers a variety of activity points and disseminate the hashtags (posted with the photographs in block 930). These activities also disseminate the opinions of the consumers regarding their experiences with (and pictures of) products associated with the brand B1 to the thousands of other non-involved (or unregistered) consumers who happen to be following the social-network accounts of the users U1-U5.

These consumers may also use client application 210 to upload text describing new ideas of their own for future contests and all consumers may vote on (or rate) these new ideas. These user supplied contest ideas may themselves be used as the basis for a contest. For example, the user U3 may submit the new contest idea “The Coolaroo shoes I would die for,” and other users may submit different new contest ideas. During the course of the new idea contest, other users may rate the new contest idea submitted by the user U3 highest amongst the new ideas submitted. Thus, the platform 100 would declare the user U3 the winner of the new-idea contest.

As mentioned above, each of the contests started by the platform 100 ends at an end time associated with the contest. The platform 100 has an internal clock (not shown) that used to determine the end of a contest and supply the end time to the client application 210. During the course of the contest, the clock 316 on the contest interface 310 (depicted in FIG. 6A) displays the contest's end time so the users U1-U5 may see when the contest is nearing an end. When the clock reaches the end time, the platform 100 tallies the photograph ratings and activity points for each of the users U1-U5 who participated in the contest. Then, the platform 100 calculates which of the users U1-U5 who participated in the contest won the contest based on a combination of photograph ratings and activity points. The platform 100 announces the winner and runners-up to all of the users U1-U5 via notifications within the client application 210 and external emails. The platform 100 publishes the winner and runners-up via the web services 220 (see FIGS. 5A-5C) to one or more websites (and/or web services) associated with or controlled by the brand B1 (e.g., Coolaroo's web site and Facebook page). Then, the platform 100 re-sets the status of contest “My hottest Coolaroo nightclub outfit” from “Current” to “Past” (effectively making it available for display but unavailable for new photograph submissions via the client application 210). The platform 100 may then publishes a new contest, such as the winning new contest idea: “The Coolaroo shoes I would die for.”

The platform 100 may disseminates user supplied photographs and opinions regarding products sold by the brand B1 to thousands of friends of the users U1-U5 along with hashtags associated with the brand B1 to thereby expose the brand B1 and general message to many consumers who might not otherwise have heard of the brand B1.

As is appreciated by those of ordinary skill in the art, the platform 100 may be duplicated readily from one set of servers to another, and each duplicate instance of the platform may be customized to match a customer's particular business, organizational, and marketing needs.

### Computing Devices

FIG. 12 is a diagram of hardware and an operating environment in conjunction with which implementations of the one or more computing devices of the system 10 (see FIG. 2) and the platform 100 (see FIG. 4A) may be practiced. The description of FIG. 12 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 12 includes a general-purpose computing device in the form of the computing device 12. Each of the computing devices of FIGS. 2 and 4A may be substantially identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feed back game controller).

The input devices described above are operable to receive user input and selections. Together the input and display devices may be described as providing a user interface.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 12 include a local-area network (LAN) 51 and a wide-area network (WAN) 52. Such networking environments are commonplace in offices, enterprise-wide computer networks, intranets and the Internet. The network 180 (see FIG. 2) may be implemented using one or more of the LAN 51 or the WAN 52 (e.g., the Internet).

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods described above. Such instructions may be stored on one or more non-transitory computer-readable media.

In some embodiments, the system memory 22 stores computer executable instructions that when executed by one or more processors cause the one or more processors to generate the user interfaces illustrated in FIGS. 6A-6L and described above. Such instructions may be stored on one or more non-transitory computer-readable media.

In some embodiments, the system memory 22 stores computer executable instructions that when executed by one or more processors cause the one or more processors to perform the methods 500-900 illustrated in FIGS. 7-11, respectively, and described above. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A system comprising:
a content storage configured to store user information for a plurality of users, and a plurality of photographs, each of the photographs being associated with a common theme;
a network of computing devices configured to communicate with the content storage and a plurality of client computing devices operated by the plurality of users, the network of computing devices comprising a plurality of application instance computing devices that when operating independently or together are configured to:
collect the user information from the plurality of users and store the user information in the content storage to thereby register the plurality of users with the network of computing devices;
receive the plurality of photographs from the plurality of users via the plurality of client computing devices after a description of the common theme has been published;
store the plurality of photographs in the content storage;
receive, for each of the plurality of photographs, identifications of multiple external and independently operated social networks upon which the photograph is to be posted;
post each of the plurality of photographs on the social networks identified in the identifications associated with the photograph;
receive a new request from a new client computing device operated by a new user to register with the network of computing devices in response to the posting;
collect new user information from the new user and store the new user information in the content storage to thereby register the new user the network of computing devices;
receive a new photograph from the new client computing device after the new user has been registered, the new photograph being associated with new identifications of ones of the social networks upon which the new photograph is to be posted;
store the new photograph in the content storage; and
post the new photograph on the social networks identified in the new identifications to thereby crowdsource collection of photographs across the multiple external and independently operated social networks.

2. The system of claim 1, wherein when operating independently or together, the plurality of application instance computing devices are further configured to:
automatically generate a hashtag associated with each of the plurality of photographs;
store the hashtag associated with each photograph in the content storage;
post the hashtag associated with each of the plurality of photographs along with the photograph;
automatically generate a new hashtag and associate the new hashtag with the new photograph;
store the new photograph and the new hashtag in the content storage; and
post the new hashtag along with the new photograph.

3. The system of claim 1 wherein the common theme is associated with a company that is associated with a website, and
when operating independently or together, the plurality of application instance computing devices are further configured to provide the plurality of photographs and the new photograph to the website for display thereby.

4. The system of claim 1 wherein when operating independently or together, the plurality of application instance computing devices are further configured to:
receive a rating for the new photograph from at least one of the plurality of users; and
display the rating to the plurality of users and the new user.

5. The system of claim 1 wherein when operating independently or together, the plurality of application instance computing devices are further configured to:
receive ratings for each of the plurality of photographs and the new photograph from the plurality of users; and
select a winning photograph based upon the ratings.

6. A computer implemented method comprising:
registering, by a computer system, a plurality of users each operating a different client computing device;
in response to a description of a theme having been published, receiving, at the computing system, a different photograph from each of the different client computing devices, each different photograph being associated with identifications of multiple external and independently operated social networks upon which the photograph is to be posted;
posting, by the computer system, each different photograph received on the social networks identified in the identifications associated with the different photograph;
receiving, at the computer system, a new request from a new client computing device operated by a new user to register with the computer system in response to the posting;
registering, by the computer system, the new user;
receiving, at the computer system, a new photograph from the new client computing device after the new user has registered with the computing system, the new photograph being associated with new identifications of ones of the social networks upon which the new photograph is to be posted; and
posting, by the computer system, the new photograph on the social networks identified in the new identifications to thereby crowdsource collection of photographs across the multiple external and independently operated social networks.

7. The method of claim 6 wherein posting each different photograph further comprises providing at least one hashtag with the different photograph.

8. The method of claim 6 further comprising:
providing a copy of a client application to each different client computing device and the new client computing device, wherein each of the plurality of users is registered via the copy of the client application provided to the different client computing device operated by the user, and the new user is registered via the copy of the client application provided to the new client computing device operated by the new user.

9. The method of claim 8 wherein the client application is configured based on the theme,
posting each different photograph further comprises providing at least one hashtag with the different photograph, and
the hashtag is associated with the theme.

10. The method of claim 6 wherein the theme is associated with a company that is associated with a website, and the method further comprises:
providing each different photograph and the new photograph to the website for display thereby.

11. The method of claim 6 further comprising:
receiving a rating for the new photograph from at least one of the plurality of users; and
displaying the rating to the plurality of users and the new user.

12. The method of claim 6 further comprising:
receiving ratings for each different photograph and the new photograph from the plurality of users; and
selecting a winning photograph based upon the ratings.
